(19) United States
(12) Patent Application Publication
(10) Pub. No.: US 2015/0032619 A1
(43) Pub. Date: Jan. 29, 2015

(54) COMMUNICATION NETWORK FOR COLLECTING DATA AND EXECUTING ELECTRONIC TRANSACTION SERVICES

(71) Applicant: Bank of America Corporation, Charlotte, NC (US)

(72) Inventors: Joseph B. Castinado, Northglenn, CO (US); Gregory G. Farr, Charlotte, NC (US); Richard H. Thomas, Charlotte, NC (US); Shilpoo Agrawal, Charlotte, NC (US); Matthew J. Stowell, Charlotte, NC (US); Bonnie L. Dolan, Lincoln, CA (US)

(73) Assignee: Bank of America Corporation, Charlotte, NC (US)

(21) Appl. No.: 13/949,458

(22) Filed: Jul. 24, 2013

(51) Int. Cl. G06Q 20/42

(52) U.S. Cl. CPC G06Q 20/42
USPC 705/44

(57) ABSTRACT

In certain embodiments, a system for executing electronic transaction services comprises one or more interfaces operable to receive access credentials for a plurality of accounts held with a plurality of enterprises, wherein the plurality of accounts are associated with an entity and one or more processors communicatively coupled to at least one of the one or more interfaces, the one or more processors operable to access, account data from the plurality of accounts, monitor transactions in the plurality of accounts, determine one or more transaction patterns, determine one or more proposed transactions, wherein the one or more proposed transactions represent electronic transfers of funds involving one or more of the plurality of accounts, and determine one or more advantages to the entity associated with the one or more proposed transactions.

### TECHNICAL FIELD

This disclosure relates generally to a communication network for collecting data and executing electronic transaction services.

### BACKGROUND

Individuals and organizations often utilize a number of electronic transaction services involving a number of different entities. Entities may pay or charge various amounts for particular electronic transaction services. Criteria for incurring payments and charges, and the amounts of payments and charges, are often subject to regular changes. Individuals and organizations that maintain a number of accounts with a number of entities are often unable to optimize their utilization of electronic transaction services to reduce charges and to increase payments.

Electronic transaction service providers serve individuals and organizations that often also receive electronic transaction services from other electronic transaction service providers. Electronic transaction service providers may not have access to electronic transaction service data maintained by other service providers. Additionally, electronic transaction service providers may not be aware of how individuals and organizations utilize their electronic transaction services, or the current status of pending electronic transaction services. Accordingly, electronic transaction service providers are often unable to direct individuals and organizations they serve to useful electronic transaction services, prevent abuse of electronic transaction services, or to obtain current information about pending electronic transaction services.

### SUMMARY OF EXAMPLE EMBODIMENTS

According to embodiments of the present disclosure, disadvantages and problems associated with providing electronic transaction services may be reduced or eliminated.

In an embodiment, a system for executing electronic transaction services, comprises one or more interfaces operable to receive access credentials for a plurality of accounts held with a plurality of enterprises, wherein the plurality of accounts are associated with an entity, and one or more processors communicatively coupled to at least one of the one or more interfaces, the one or more processors operable to access, based on the received access credentials, account data from the plurality of accounts, monitor transactions in the plurality of accounts based on the accessed account data, determine one or more transaction patterns based on the monitored transactions in the plurality of accounts, determine one or more proposed transactions based on the one or more determined patterns, wherein the one or more proposed transactions represent electronic transfers of funds involving one or more of the plurality of accounts, and determine one or more advantages to the entity associated with the one or more proposed transactions, and generate a notification message to a user associated with the entity describing the one or more proposed transactions and the one or more advantages.

In a further embodiment, a system for executing electronic transaction services comprises one or more interfaces operable to receive service data related to a plurality of service requests for a plurality of electronic transaction services from a plurality of users, receive a first message identifying a user, an electronic transaction service, and a problem associated with the user and the electronic transaction service, communicate a second message to one or more service administrators identifying the user, the electronic transaction service, and the problem, and receive, from at least one of the one or more service administrators, authorization credentials and a limit to the use of the electronic transaction service for the user, and one or more processors communicatively coupled to at least one of the one or more interfaces, the one or more processors operable to determine whether the authorization credentials satisfy authorization criteria, and if the authorization credentials satisfy the authorization criteria, apply the limit to a subsequent service request by the user, and the one or more interfaces further operable to communicate to the user a third message notifying the user of the limit to the use of the electronic transaction service, if the authorization credentials satisfy the authorization criteria.

In another embodiment, a system for executing electronic transaction services comprises one or more processors operable to access first charge information associated with electronic transactions related to a plurality of nodes, access second charge information associated with electronic transactions related to a plurality of regulatory authorities, wherein each regulatory authority has authority over one or more of the plurality of nodes, access a plurality of previously executed electronic transactions associated with a user, determine one or more transaction patterns based on the plurality of previously executed electronic transactions, determine a current cost associated with the one or more transaction patterns based at least in part on the first and second charge information, and determine, based at least in part on the first and second charge information, one or more proposed electronic transactions routed through two or more of the plurality of nodes and two or more of the plurality of authorities, wherein the one or more proposed electronic transactions are associated with a proposed cost less than the current cost, and one or more interfaces communicatively coupled to at least one of the one or more processors, the interface operable to generate a message to the user identifying the one or more proposed transactions.

In yet another embodiment, a system for executing electronic transaction services comprises one or more interfaces operable to receive access credentials for a plurality of accounts held with a plurality of enterprises, wherein the plurality of accounts are associated with an entity, one or more processors communicatively coupled to at least one of the one or more interfaces, the one or more processors operable to access, based on the received access credentials, account data from the plurality of accounts, the one or more interfaces further operable to receive an electronic transaction service request from a user to execute a fund transfer involving a first of the plurality of accounts associated with the entity, the one or more processors further operable to determine one or more second of the plurality of accounts associated with the entity, and filter the one or more second of the plurality of accounts based on fund transfer limitations associated with the one or more second accounts to determine one or more proposed accounts, the one or more interfaces further operable to generate a communication to the user with an identification of the one or more proposed accounts to associate with the fund transfer, and receive from the user a selection of one of the one or more proposed accounts, and the one or more processors further operable to execute the fund transfer with the selected proposed account.

Certain embodiments of the present disclosure may provide one or more technical advantages having specific technical effects. In certain embodiments, a system for executing electronic transaction services is operable to provide a user access to a plurality of accounts associated with the user through a single interface, thereby conserving the bandwidth, memory, and computational resources consumed by the user accessing the accounts through separate interfaces.

In an embodiment, a system for executing electronic transaction services is operable to propose electronic transaction services to users based on accessed electronic transaction service data from a plurality of accounts, thereby conserving the bandwidth, memory, and computational resources consumed by individual users each accessing the service data and determining the proposed transaction services.

In another embodiment, a system for executing electronic transaction services is operable to restrict use of electronic transaction services, thereby conserving the bandwidth, memory, and computational resources consumed by overuse of electronic transaction services.

In yet another embodiment, a system for executing electronic transaction services is operable to determine user registration, initiation, and/or completion of electronic transaction services, thereby conserving the bandwidth, memory, and computation resources consumed by obtaining user registration, initiation, and/or completion of electronic transaction services from users.

In still yet another embodiment, a system for executing electronic transaction services is operable to identify a system component currently responsible for an electronic transaction service, thereby conserving the bandwidth, memory, and computation resources consumed by searching all system components for the system component currently responsible for an electronic service transaction.

In a further embodiment, a system for executing electronic transaction services is operable to identify incorrect accounts involved in electronic transaction services before completing the electronic transaction service, thereby conserving the bandwidth, memory, and computation resources consumed by correcting erroneous electronic transaction services after completion.

In certain embodiments, a system for executing electronic transaction services is operable to determine costs associated with an electronic transaction before executing the transaction, thereby conserving the computational resources and bandwidth consumed by determining costs associated with transactions by executing and storing the results of numerous transactions.

In another embodiment, a system for executing electronic transaction services is operable to obtain charge information associated with electronic transaction services for a plurality of nodes and store the charge information in a centralized database before receiving a request to execute an electronic transaction, thereby reducing the computation resources and bandwidth consumed by attempting to obtain charge information from remote sources through a burst of requests after receiving a request to execute an electronic transaction.

In yet another embodiment, a system for executing electronic transaction services is operable to reduce transaction time associated with an electronic transaction by routing the transaction through nodes with the lowest transaction time, thereby reducing the computational resources and bandwidth consumed routing the transaction through nodes with longer transaction times.

In still yet another embodiment, a system for executing electronic transaction services is operable to increase the efficiency of the electronic transaction by routing the transaction on a route with the least number of nodes, thereby conserving the bandwidth and computational resources consumed by routes using more nodes.

In another embodiment, a system for executing electronic transaction services is operable to increase the efficiency of the electronic transaction by routing the transaction on a route with lowest transaction cost, thereby conserving the bandwidth and computational resources consumed by attempting transactions to determine their cost.

In yet another embodiment, a system for executing electronic transaction services is operable to increase the efficiency of electronic transaction services by maintaining updated charge information for nodes in order to avoid routing the transaction through nodes with inaccurate charge information, thereby conserving the computational resources and bandwidth consumed reconciling inaccuracies after a transaction has occurred (e.g., through customer service claims investigation).

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates a block diagram of an example embodiment of a system for executing electronic transaction services;

FIG. 2 illustrates a table of database fields that may be used in an example embodiment of executing electronic transaction services;

FIG. 3 illustrates a table of database fields that may be used in an example embodiment of executing electronic transaction services;

FIGS. 4A-D illustrate tables of database fields that may be used in example embodiments of executing electronic transaction services;

FIG. 5 illustrates a table of database fields that may be used in an example embodiment of executing electronic transaction services;

FIG. 6 illustrates an example embodiment of a method for executing electronic transaction services;

FIG. 7 illustrates an example embodiment of a method for executing electronic transaction services;

FIG. 8 illustrates an example embodiment of a method for executing electronic transaction services; and

FIG. 9 illustrates an example embodiment of a method for executing electronic transaction services.

### DETAILED DESCRIPTION

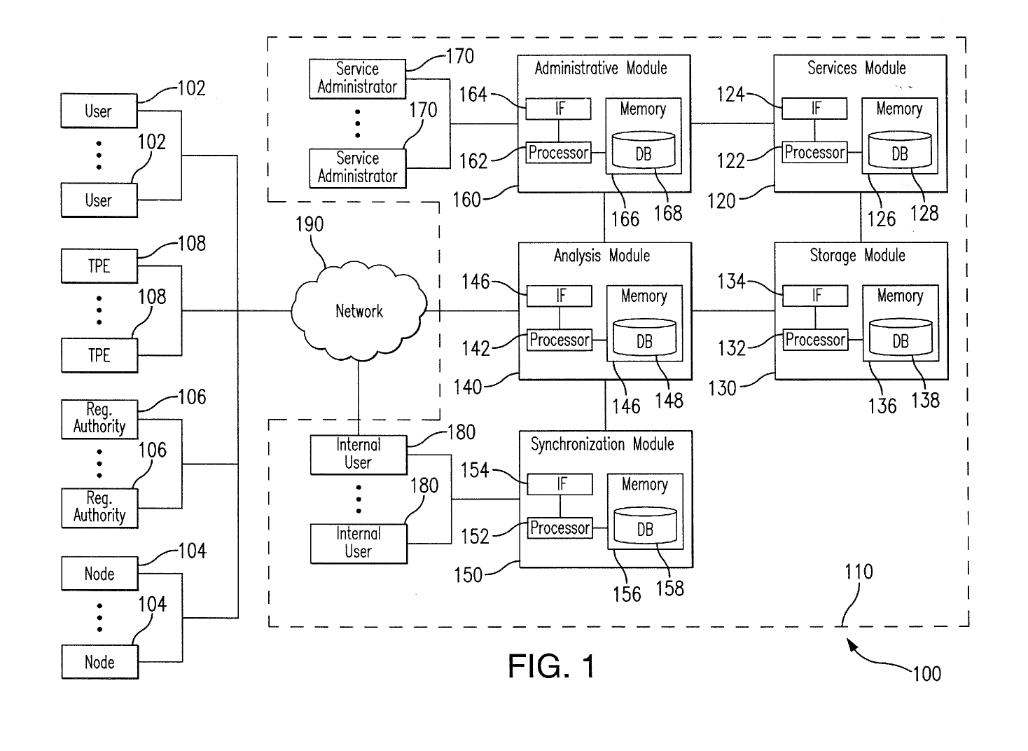

Embodiments of the present disclosure and its advantages are best understood by referring to FIGS. 1 through 9 of the drawings, like numerals being used for like and corresponding parts of the various drawings.

In certain embodiments, a system for executing electronic transaction services receives access credentials for a plurality of accounts (e.g., from an authorized user). The plurality of accounts may be held by a plurality of different enterprises such as financial institutions (e.g., commercial banks, savings and loan associations, credit unions, Internet banks, mutual fund companies, brokerage firms, credit card companies, or other financial organization), business entities, regulatory entities, or other organization. One or more accounts may be associated with a particular entity, and accounts may be organized by the entities associated with the account (e.g., account owner, authorized users, category of account owner, or other suitable characteristic of an entity).

In an embodiment, the system accesses account data from the plurality of accounts with the received access credentials. Account data may include any suitable data associated with an account that is accessible with the access credentials, for example, interest rates, charges, charge criteria (e.g., requirements for particular charges to an account), charge descriptions (e.g., descriptions of particular charges to an account), fund transfers (e.g., deposits and withdrawals), fund transfer source accounts (e.g., the source account of a fund transfer), fund transfer destination accounts (e.g., the destination account of a fund transfer), or any other data associated with an account. In certain embodiments, the system provides a user access to one or more of the accounts through a single interface, for example, an user facing interface (e.g., online user portal). In particular embodiments, the system monitors transactions involving one or more of the plurality of accounts based on the accessed account data and identifies transaction patterns. Transaction patterns may include patterns in transaction amount, transaction source, transaction destination, transaction timing, transaction charges, interest on transaction accounts, or any other pattern in electronic transaction characteristics.

In an embodiment, the system determines one or more proposed transactions based on the one or more determined transaction patterns and one or more advantages associated with the one or more proposed transactions. Advantages may include reducing charges associated with electronic transaction services, reducing interest charged by accounts, increasing interest paid on accounts, decreasing the execution time of a transaction, or any other advantage to a user associated with an electronic transaction. In certain embodiments, the system communicates one or more proposed transactions to a user (e.g., a user associated with a transaction, account, and/or entity). The system may further communicate one or more advantages of the proposed transaction. In an embodiment, the system includes an application (e.g., an embedded application or a hyperlink to an application) operable to allow the user to execute one or more of the proposed transactions.

In a further embodiment, the system is operable to access service data related to a plurality of electronic transaction service requests. Service data may include any data associated with the plurality of service requests, for example, requesting user, time of the request, accounts associated with the request, users associated with the request, fund transfer amounts associated with the request, or other data related to the plurality of service request. In an embodiment, the system is operable to receive service problem messages indicating a problem with an electronic transaction service, for example, service abuse, service malfunctions, service change requests, additional services requested, changing user privileges associated with an electronic transaction service (e.g., adding, removing, or limiting authorized usage privileges of one or more users), or other problem with an electronic transaction service. Service problem messages may identify a user associated with the problem, a service associated with the problem, and/or a description of the service problem, and may be communicated by users or administrators.

In certain embodiments, the system communicates an administrator message to one or more electronic transaction service administrators describing the problem, the electronic transaction service, and/or one or more users associated with the problem. In an embodiment, the system only communicates an administrator message after receiving a threshold number of problem messages. The system may receive authorization credentials from one or more service administrators and a limit to the use of the electronic transaction service for one or more users and/or additional privileges to the use of the electronic transaction service for one or more users. In particular embodiments, the system determines whether the authorization criteria received from the one or more service administrators satisfies authorization criteria, and, if the authorization credentials satisfy the authorization criteria, applies the identified limit and/or additional privileges to associated users. The system may generate a notification message for one or more users affected by the limit or additional privilege notifying them of the change.

In an embodiment, the system is operable to receive and apply filter criteria (e.g., from a user or service administrator) for service data to determine a number of users registering for, initiating, and/or completing particular electronic transaction services. The filter criteria may include an identification of a particular territory, user, group of users, electronic transaction service, or any other suitable filter criteria for service data. In another embodiment, the system is operable to determine one or more service requests that have been initiated and not completed within a threshold amount of time. The system may determine a status of the service request that identifies a component of the system currently processing the service request, for example, based on a trace ID for each service request that is updated by components of the system as they process the service request.

In particular embodiments, a system obtains information associated with nodes or regulatory authorities involved in electronic transaction services in order to create a centralized repository of transaction information. A rating may be generated for transaction information based on various qualities of the transaction information. In certain embodiments, the ratings are used to maintain updated and accurate transaction information. Transaction information and associated ratings may be stored in one or more memories to create a centralized repository of transaction information so that transaction information relating to a particular electronic transaction (e.g., transaction information relating to nodes or entities involved in a specific transaction) can be quickly identified. In certain embodiments, the system receives requests for transaction information or for calculations based on transaction information.

The system may provide transaction information responsive to the requests and perform calculations based on the transaction information. In particular embodiments, the system may propose transactions that reduce transaction time to execute an electronic transaction by providing real-time charge information for an electronic transaction before executing the transaction, may increase the efficiency of electronic transaction services by determining electronic transaction routes through nodes or entities with the lowest charges, may increase the efficiency of electronic transaction services by determining transaction routes through nodes or entities with the fastest transaction time, or other useful operation using transaction data to facilitate electronic transaction services. The system may propose transactions involving particular nodes and/or regulatory authorities only if the ratings for the nodes and/or regulatory authorities are over a particular threshold. In certain embodiments, rating information for nodes and/or regulatory authorities is regularly updated based on additional transaction records.

In an embodiment, a system is operable to identify one or more accounts associated with an entity, user, and/or electronic transaction service for use in a fund transfer. The system may filter the identified accounts based on criteria that restrict the type of accounts that can be utilized in particular electronic transaction services. For example, fund transfers that are credit payments cannot be paid from credit accounts and fund transfers that are mortgage payments cannot be paid from credit accounts, retirement accounts or certificate of deposit accounts. In certain embodiments, the system communicates to a user (e.g., a user associated with an account, an electronic transaction service, or a user associated with an entity) a message identifying the one or more proposed accounts for the fund transfer. The system may receive a selection from the user of one of the proposed accounts for the fund transfer and execute the fund transfer with the selected account. In particular embodiments, the message identifying the one or more proposed accounts for the fund transfer further includes an application (e.g., an embedded application or a hyperlink to an application) operable to allow the user to select one or more of the proposed accounts.

FIG. 1 illustrates a block diagram of an example embodiment of a system for executing electronic transaction services. According to an embodiment, system 100 includes users 102, nodes 104, regulatory authorities 106, third party enterprises (“TPEs”) 108, enterprise 110, and network 190.

Users 102 may include businesses or other commercial organizations, government agencies, individuals, or any other suitable user. In certain embodiments, users 102 access electronic transaction services from enterprise 110 (e.g., from services module 120). For example, electronic transaction services may include executing transactions (e.g., fund transfers), proposing transactions (e.g., fund transfers with lower costs or fund transfers to accounts with higher interest yields), providing advantages of proposed fund transfers, providing access to a plurality of accounts from one or more sources of record (e.g., an entity maintaining an account) through a single application and/or interface (e.g., a user facing application), proposing accounts to involve in a transaction, adding or removing limitations to transaction services for particular users 102 and/or accounts, identifying a component of system 100 currently responsible for a transaction, determining a number of users 102 that have registered for, initiated, and/or completed one or more types of transactions in one or more territories, identifying misuse of transaction services, applying implementation changes to transaction services (e.g., to presentation and/or functionality of transaction services), limiting the types of accounts involved in particular transactions, identifying beneficial routes for fund transfers (e.g., low cost, high reliability, and/or fast processing time), identifying and updating ratings for charges associated with nodes 104 and/or regulatory authorities 106, or any other suitable service related to electronic transactions. In certain embodiments, fund transfers include fund transfers made in fulfillment of a legal obligation, fund transfers made at the discretion of the transferor, fund transfers made in fulfillment of a legal obligation where the type of transfer is within the discretion of the transferor, or any other suitable fund transfer.

Nodes 104 represent components through which electronic transaction services are routed. Electronic transaction services may include any form of financial transaction executed electronically. In certain embodiments, electronic transaction services represent currency values being transferred between nodes 104, for example, fund transfers or other fund transfer services. Transaction services may also represent other fund transfers (e.g., bill pay, account transfers, donation requests, or wire transfers). In an embodiment, nodes 104 include organizations such as commercial banks, savings and loan associations, credit unions, Internet banks, mutual fund companies, brokerage firms, credit card companies, or other provider of electronic transaction services. In certain embodiments, nodes 104 apply charges for servicing electronic transaction services. Some nodes 104 may apply different charges for a transaction service than other nodes 104 for similar electronic transaction services.

In particular embodiments, nodes 104 are under the jurisdiction of one or more regulatory authorities 106. Regulatory authorities 106 represent any body with regulatory authority over nodes 104. In certain embodiments, regulatory authorities 106 include trade associations, governments, government agencies, or other body that may have regulatory authority over nodes 104. Regulatory authorities 106 may require certain charges be applied (e.g., by nodes 104) to electronic transaction services and different regulatory authorities 106 may require different charges for similar electronic transaction services. In certain embodiments, a node 104 may apply a charge for another node 104 or for a regulatory authority 106. Nodes 104 and regulatory authorities 106 may have distribution channels for communicating charge information, such as publications, official communications, official websites, official points of contact, or other suitable channel.

Third party enterprises 108 represent entities that are external, separate, and/or distinct from enterprise 110. In certain embodiments, third party enterprises 108 do not maintain and/or operate components of enterprise 110, such as services module 120, storage module 130, analysis module 140, synchronization module 150, and administrative module 160. For example, enterprise 110 may control the access of third party enterprises 108 to enterprise 110 services (e.g., services module 120, storage module 130, analysis module 140, synchronization module 150, and administrative module 160). Third party enterprises 108 may be any suitable type of business entity. In an embodiment, third party enterprises 108 have different business units or subdivisions that handle different business activities. Third party enterprises 108 may include organizations such as commercial banks, savings and loan associations, credit unions, Internet banks, mutual fund companies, brokerage firms, credit card companies, or other provider of electronic transaction services.

Enterprise 110 represents an entity that maintains and/or operates services module 120, storage module 130, analysis module 140, synchronization module 150, and/or administrative module 160. Enterprise 110 may refer to a node 104, however, enterprise 110 represents any suitable type of entity. In certain embodiments, enterprise 110 has different business units or subdivisions that handle different business activities. Different subdivisions of enterprise 110 may maintain and/or operate one or more of services module 120, storage module 130, analysis module 140, synchronization module 150, and/or administrative module 160. In particular embodiments, enterprise 110 may include organizations such as commercial banks, savings and loan associations, credit unions, Internet banks, mutual fund companies, brokerage firms, credit card companies, or other provider of electronic transaction services.

Services module 120 represents a component of enterprise 110 operable to provide electronic transaction services, for example, for users 102, nodes 104, regulatory authorities 106, TPEs 108, and/or internal enterprise users 180. Electronic transaction services may include any suitable service associated with an electronic transaction (e.g., a fund transfer). For example, service module 120 may execute fund transfers, propose fund transfers (e.g., fund transfers to execute or fund transfers to discontinue) and/or advantages of proposed fund transfers to users 102, communicate electronic transaction service information, receive and apply account access credentials, access accounts, provide access to a plurality of accounts with an application (e.g., an application embedded in a message or accessible through user portal), receive requests to execute electronic transaction services, access service data, access account data, generate notification messages, or any other service related to electronic transactions. Account data may include the time of a transaction, the location of transaction, the type of transaction, the execution method of the transaction, the device and/or interface used for a transaction, or any other suitable data related to an account and/or transactions related to an account. In certain embodiments, services module 120 includes processor 122, interface 124, memory 126, and database 128. Services module 120 may be communicatively coupled to one or more of storage module 130, analysis module 140, synchronization module 150, administrative module 160, service administrators 170, internal enterprise users 180, users 102, nodes 104, regulatory authorities 106, and TPEs 108.

Storage module 130 represents a component operable to store information for system 100. Storage module 130 may receive information from components of system 100, such as services module 120, analysis module 140, synchronization module 150, administrative module 160, service administrators 170, internal enterprise users 180, users 102, nodes 104, regulatory authorities 106, TPEs 108, or any other component of system 100. Storage module 130 may receive and store any type of information for system 100, for example, electronic transaction records, service requests, account data, charge information (e.g., for nodes 104 and/or authorities 106), charge information ratings (e.g., for nodes 104 and/or authorities 106), currency exchange rate information, effective dates for charge information (e.g., dates after which the information becomes valid), expiration dates for charge information (e.g., dates after which the information becomes invalid), transaction times for electronic transaction services involving nodes 104, service records (e.g., claims of errors in transactions), transaction patterns, proposed transactions, advantages of proposed transactions, current component processing pending service requests, trace IDs, transaction restrictions, or any other suitable information received or accessed by components of enterprise 110. In certain embodiments, storage module 130 includes processor 132, interface 134, memory 136, and database 138.

Analysis module 140 represents a component operable to access and manipulate received and/or stored data (e.g., from storage module 130). Analysis module 140 may receive information from components of system 100, such as services module 120, storage module 130, synchronization module 150, administrative module 160, service administrators 170, internal enterprise users 180, users 102, nodes 104, regulatory authorities 106, TPEs 108, or any other component of system 100. In certain embodiments, analysis module 140 accesses electronic transaction data (e.g., of users 102, nodes 104, regulatory authorities 106, and/or TPEs 108) from storage module 130 and identifies electronic transaction patterns. For example, analysis module 140 may monitor one or more accounts (e.g., associated with users 102 or an entity) and identify patterns in the timing, amount, source, destination, account interest, charges, or other characteristic of electronic transaction services. In an embodiment, analysis module 140 identifies proposed electronic transaction services and an advantage of the proposed electronic transaction services compared to identified current patterns of electronic transaction services (e.g., reduce charges, increase speed, increase reliability of transactions, increase return from interest, or other benefit). In certain embodiments, analysis module 140 includes processor 142, interface 144, memory 146, and database 148.

Synchronization module 150 represents a component operable to associate one or more accounts with an electronic transaction service according to particular transaction criteria. For example, users 102 may identify an account for a fund transfer and synchronization module 150 may identify other accounts related to one or more of users 102 and/or the account. In certain embodiments, particular account types cannot be used in particular electronic transaction services. For example, fund transfers to pay credit balances or mortgage balances may not be from credit, retirement, or certificate of deposit accounts, or other suitable restriction on the types of accounts used in electronic transaction services. In an embodiment, users 102 may receive a message identifying one or more of the associated accounts identified by synchronization module 150 with an option to select one or more of the associated accounts to involve in the transaction (e.g., as source or destination accounts in a fund transfer).

Synchronization module 150 may identify errors in accounts identified by users 102. In certain embodiments, user 102 identifies an account incorrectly (e.g., typos, transposed numbers, wrong account, etc.) and synchronization module 150 is operable to determine that there was an error with the identified account and determine one or more associated accounts that can be proposed to user 102, for example, based on transaction patterns associated with user 102. If user 102 transposed numbers in an account number, synchronization module 150 may be operable to determine that that user 102 has not used the account number before or that is an invalid account number, and identify previously used account numbers that are similar to the account number identified by user 102. In certain embodiments, synchronization module 150 includes processor 152, interface 154, memory 156, and database 158. Synchronization module 150 may be communicatively coupled to one or more of services module 120, storage module 130, analysis module 140, administrative module 160, service administrators 170, internal enterprise users 180, users 102, nodes 104, regulatory authorities 106, and TPEs 108.

Administrative module 160 represents a component operable to control electronic transaction service access privileges and limits, identify misuse of electronic transaction services, determine a component currently processing one or more transaction service requests, and/or identify user 102 registration, initiation, and/or completion of electronic transaction services. Administrative module 160 may be operable to identify misuse of electronic transaction services (e.g., by monitoring number of uses, number of complaints, rate of uses, transaction amounts, and/or number of accounts used). In certain embodiments, administrative module 160 notifies service administrators 170 of electronic transaction service misuse. For example, if administrative module 160 receives a complaint (e.g., an issue flag or complaint message), or a threshold number of complaints, about a user 102 or transaction service, then administrative module 160 may notify service administrators 170 in an administrator message. In certain embodiments, an administrator message identifies one or more of an electronic transaction service, one or more associated users 102, and/or an identification of the complaint.

Administrative module 160 may monitor pending electronic transaction service requests in order to identify components currently processing service requests. In an embodiment, administrative module 160 maintains a trace ID for each pending service request that identifies the component currently processing the service request. For example, components of system 100 may update the trace ID for a service request after processing the service request. In certain embodiments, administrative module 160 is operable to determine a number of users 102 that have registered for, initiated, and/or completed a service request for one or more electronic transaction services. Administrative module 160 may be able to filter user 102 service registration, initiation, and/or completion information by territory, user 102, electronic transaction service, or any other suitable criteria. In particular embodiments, administrative module 160 is operable to adjust the electronic transaction service privileges and limits for users 102. For example, administrative module 160 may restrict the types of transactions available to users 102 (e.g., transaction amount, transaction account, transaction number, or other criteria).

In an embodiment, administrative module 160 is accessible to entities outside of enterprise 110 (e.g., users 102, TPEs 108, and/or regulatory authorities 106) to enable the outside entities to utilize the functions of administrative module 160. For example, TPE 108 may communicate data to enterprise 110 for use by service module 120, storage module 130, analysis module 140, synchronization module 150, and/or administrative module 160, and TPE 108 may utilize administrative module 160 to access the data, control access to the data, and/or manipulate the data. In certain embodiments, administrative module 160 includes processor 162, interface 164, memory 166, and database 168. Administrative module 160 may be communicatively coupled to one or more of services module 120, storage module 130, analysis module 140, synchronization module 150, service administrators 170, internal enterprise users 180, users 102, nodes 104, regulatory authorities 106, and TPEs 108.

Service administrators 170 represent persons associated with enterprise 110 who are authorized to control the electronic transaction service access privileges of users 102, TPEs 108, and/or internal users 180, and/or adjust the implementation (e.g., presentation and/or functionality) of electronic transaction services. Service administrators 170 may be able to access information (e.g., through administrative module 160, analysis module 140, and/or storage module 130) to identify service issues (e.g., complaints or abuse of transaction services), to determine service limits for users 102 and/or accounts, to identify components that are not properly processing transaction service requests (e.g., by identifying components currently processing service requests that are not completed within a threshold time), to respond to requests to change user 102 access privileges for electronic transaction services, to determine a number of users registering for, initiating, and/or completing particular electronic transaction services (e.g., in particular territories), to adjust the implementation of electronic transaction services (e.g., the presentation and/or functionality), or any other administrative service for system 100. In certain embodiments, service administrators 170 identify components currently processing service requests by maintaining a trace ID for transaction service requests that is updated by components as the request is processed. Service administrators 170 may be able to communicate with one or more of services module 120, storage module 130, analysis module 140, synchronization module 150, administrative module 160, internal enterprise users 180, users 102, nodes 104, regulatory authorities 106, and TPEs 108.

Internal enterprise users 180 represent entities within enterprise 110 that utilize electronic transaction services provided by enterprise 110. For example, particular individuals and/or business units associated with enterprise 110 may access one or more of services module 120, storage module 130, analysis module 140, synchronization module 150, and/or administrative module 160, for example, to develop new electronic transaction services, to improve existing electronic transaction services, for regulatory compliance, and/or any other suitable reason. In certain embodiments, internal enterprise users 180 are able to communicate with one or more of services module 120, storage module 130, analysis module 140, synchronization module 150, administrative module 160, service administrators 170, users 102, nodes 104, regulatory authorities 106, and TPEs 108.

Network 190 represents any suitable network operable to facilitate communication between components of system 100, such as services module 120, storage module 130, analysis module 140, synchronization module 150, administrative module 160, service administrators 170, internal enterprise users 180, users 102, nodes 104, regulatory authorities 106, and TPEs 108. Network 190 may include any interconnecting system capable of transmitting audio, video, electrical signals, optical signals, data, messages, or any combination of the preceding. Network 190 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100.

A module (e.g., modules 120, 130, 140, 150, and 160) may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of a module may be performed by any suitable combination of one or more servers or other components at one or more locations. In embodiments where modules represent a server, the server may be a private server, and the server may be a virtual or physical server. Additionally, a module may include any suitable component that functions as a server.

Components of system 100, such as services module 120, storage module 130, analysis module 140, synchronization module 150, and administrative module 160, may include one or more processors, interfaces, memories, and/or databases. A processor represents any computing device, such as processors 122, 132, 142, 152, and 162, configured to control the operation of one or more components of system 100. A processor may comprise one or more processors and may be a programmable logic device, a microcontroller, a microprocessor, any suitable processing device, or any suitable combination of the preceding. A processor includes any hardware or software that operates to control and process information received by a component of system 100. In certain embodiments, a processor communicatively couples to other components of system 100, such as a module (e.g., modules 120, 130, 140, 150, and 160), an interface (e.g., interfaces 124, 134, 144, 154, and 164), a memory (e.g., memories 126, 136, 146, 156, and 166), a database (e.g., databases 128, 138, 148, 158, and 168), or any other suitable component.

An interface represents any device, such as interfaces 124, 134, 144, 154, and 164, operable to receive input, send output, process the input or output, or perform other suitable operations for a component of system 100. An interface includes any port or connection, real or virtual, including any suitable hardware or software, including protocol conversion and data processing capabilities, to communicate through network 190. In certain embodiments, an interface includes a user interface (e.g., physical input, graphical user interface, touchscreen, buttons, switches, transducer, or any other suitable method to receive input from a user).

A memory represents any device, such as memories 126, 136, 146, 156, and 166 operable to store, either permanently or temporarily, data, operational software, or other information for a processor. Memory includes any one or a combination of volatile or non-volatile local or remote devices suitable for storing information. For example, a memory may include random access memory (RAM), read only memory (ROM), magnetic storage devices, optical storage devices, semiconductor storage devices, or any other suitable information storage device or a combination of these devices. A memory may include any suitable information for use in the operation of component of system 100. A memory may further include some or all of one or more databases (e.g., databases 128, 138, 148, 158, and 168).

Logic may perform the operation of any component of system 100, for example, logic executes instructions to generate output from input. Logic may include hardware, software, or other logic. Logic may be encoded in one or more non-transitory, tangible media, such as a computer-readable medium or any other suitable tangible medium, and may perform operations when executed by a computer or processor. Certain logic, such as a processor, may manage the operation of a component.

Modifications, additions, or omissions may be made to system 100. System 100 may include more, fewer, or other components. Any suitable component of system 100 may include a processor, interface, logic, memory, database, or other suitable element.

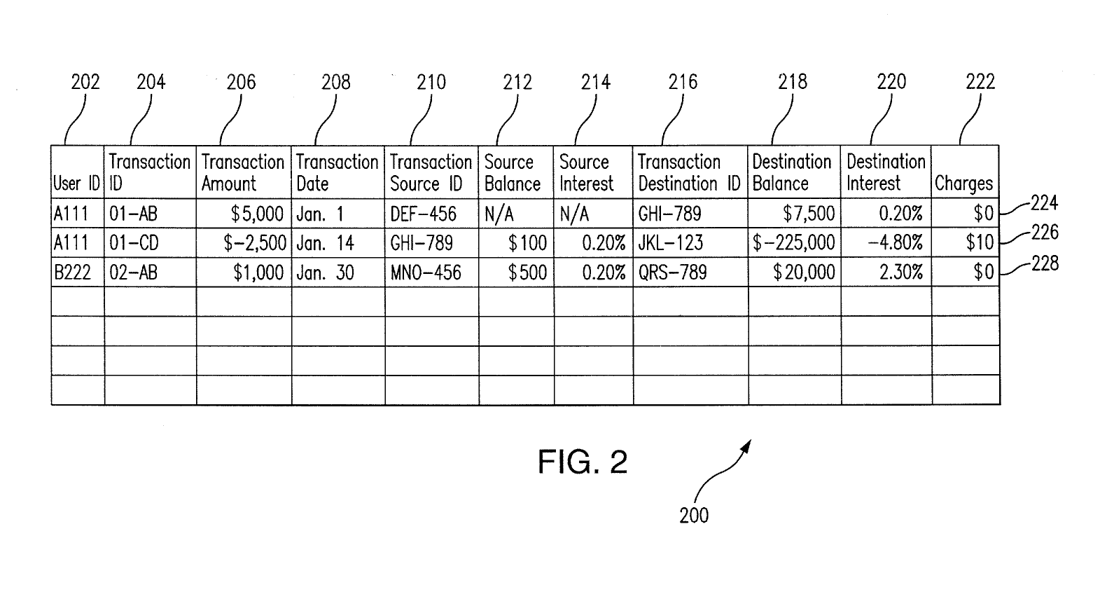

FIG. 2 illustrates a table of database fields that may be used in an example embodiment of executing electronic transaction services. In the illustrated embodiment, table 200 includes user ID field 202, transaction ID field 204, transaction amount field 206, transaction date field 208, transaction source field 210, source balance field 212, source interest field 214, transaction destination field 216, destination balance field 218, destination interest field 220, and charges field 222. User ID field 202 represents a field that includes an identifier (e.g., ID code) for particular users 102 associated with particular electronic transaction services (e.g., fund transfers). Transaction ID field 204 represents a field that includes an identifier associated with particular electronic transaction services. Transaction amount field 206 represents a field that includes an amount of money associated with a particular electronic transaction services. Transaction date field 208 represents a field that includes an execution date and/or time associated with particular electronic transaction services. Transaction source ID field 210 represents a field that includes a source account (e.g., deposit account, investment account, CD account, payment account, or any other suitable financial account) associated with particular electronic transaction services.

Source balance field 212 represents a field that includes a balance associated with a source account for particular electronic transaction services. System 100 may not have access to the balance associated with a source account for an electronic transaction, for example, because system 100 does not have access to the source of record (e.g., source financial institution) that maintains a source account for an electronic transaction. Source interest field 214 represents a field that includes an interest rate associated with a source account for particular electronic transaction services. System 100 may not have access to the interest rate associated with a source account for an electronic transaction, for example, because the source account does not have an associated interest rate or because system 100 does not have access to the source of record that maintains a source account for an electronic transaction.

Transaction destination ID field 216 represents a field that includes a destination account (e.g., deposit account, investment account, CD account, payment account, or any other suitable financial account) associated with particular electronic transaction services. Destination balance field 218 represents a field that includes a balance associated with a destination account for particular electronic transaction services. System 100 may not have access to the balance associated with a destination account for an electronic transaction, for example, because system 100 does not have access to the source of record (e.g., source financial institution) that maintains the destination account associated with an electronic transaction.

Destination interest field 220 represents a field that includes an interest rate associated with a destination account for particular electronic transaction services. System 100 may not have access to the interest rate associated with a destination account for an electronic transaction, for example, because the destination account does not have an associated interest rate or because system 100 does not have access to the source of record that maintains the destination account associated with an electronic transaction. Charges field 222 represents a field that includes charges associated with an electronic transaction (e.g., fees, taxes, penalties, or any other suitable charge). Table 200 may identify charges by the charging entity (e.g., a servicing financial institution).

Rows 224, 226, and 228 illustrate an example embodiment of database values for database fields that may be used to execute electronic transaction services. Row 224 depicts user ID field 202 of A111, transaction ID field 204 of 01-AB, transaction amount field 206 of $5,000, transaction date field 208 of January 1, transaction source ID field 210 of DEF-456, source balance field 212 of N/A, source interest field 214 of N/A, transaction destination ID 216 of GHI-789, destination balance field 218 of $7,500, destination interest field 220 of 0.2%, and charges field 222 of $0. In an embodiment, row 224 is an example of a direct deposit from a source account inaccessible by system 100 to a destination account associated with user 102 accessible by system 100 (e.g., a checking account).

Row 226 depicts user ID field 202 of A111, transaction ID field 204 of 01-CD, transaction amount field 206 of −$2,500, transaction date field 208 of January 14, transaction source ID field 210 of GHI-789, source balance field 212 of $100, source interest field 214 of 0.2%, transaction destination ID 216 of JKL-123, destination balance field 218 of −$225,000, destination interest field 220 of −4.8%, and charges field 222 of $10. In an embodiment, row 226 is an example of a mortgage payment from a checking account accessibly by system 100 to a mortgage account accessible by system 100 that has a late fee of $10.

Row 228 depicts user ID field 202 of B222, transaction ID field 204 of 02-AB, transaction amount field 206 of $1,000, transaction date field 208 of January 30, transaction source ID field 210 of MNO-456, source balance field 212 of $500, source interest field 214 of 0.2%, transaction destination ID 216 of QRS-789, destination balance field 218 of $20,000, destination interest field 220 of 2.3%, and charges field 222 of $0. In an embodiment, row 228 represents user 102 transferring funds from a checking account with a low interest rate to a savings account with a higher interest rate.

In certain embodiments, services module 120 is operable to request and receive account access credentials from users 102. Accounts may be checking accounts, savings accounts, retirement accounts, investment accounts, payment accounts, deposit accounts, loan accounts, or any other type of financial account. In certain embodiments, accounts are maintained by enterprise 110, third party enterprises 108, or other entity. Service module 120 may be operable to access accounts associated with the access credentials received from users 102 and from other accounts associated with one or more of enterprise 110 and third party enterprises 108. In an embodiment, storage module 130 is operable to store account data (e.g., requested and/or executed electronic transaction services) associated with accessed accounts. Analysis module 140 may identify transaction patterns in the accessed accounts and identify proposed transactions that have advantages to users 102 based on the identified transaction patterns. In certain embodiments, service module 120 communicates proposed transactions and advantages to users 102.

Analysis module 140 may determine a number of different proposed electronic transaction services, for example, transferring funds earlier to avoid late fees and rush fees, transferring funds from a lower interest bearing account to a higher interest bearing account, transferring funds to a debt account with an interest rate higher than an interest bearing account (e.g., from a savings account paying 0.2% interest to a student loan debt account charging 6.8% interest) or a debt account with a lower interest rate (e.g., paying less on a mortgage account with an interest rate of 4.5% and more towards a student debt account with an interest rate of 6.8%), lines of credit (e.g., when account balances are below a threshold), investment services (e.g., when low interest bearing accounts have balances above a threshold), reduction of debt accounts (e.g., reducing credit card bills), or any other suitable electronic transaction service based on account data.

In an embodiment, analysis module 140 determines that user 102 with user 102 A111 receives $5,000 on the first of every month in account GHI-789 (e.g., a paycheck direct deposit to a checking account) and pays $2,500 on the fourteenth of every month from account GHI-789 to account JKL-123 and pays a charge associated with the transaction of $10 (e.g., a mortgage payment with a late fee of $10). Analysis module 140 may determine a proposed transaction where the $2,500 in transaction 01-CD is paid on January 10 instead of January 14 with an advantage to user 102 A111 of avoiding the $10 late fee. In certain embodiments, analysis module 140 determines a proposed transaction for user 102 A111 to transfer funds from a savings account to account GHI-789, or to accept particular lines of credit, because the balance of account GHI-789 is only $100. Analysis module 140 may determine a proposed transaction where user 102 B222 transfers money from account QRS-789 to an account with an earned interest rate greater than 2.3% (e.g., a retirement account) because the balance of account QRS-789 is greater than a threshold amount (e.g., $10,000) and is an account with an earned interest rate below a threshold amount (e.g., 4%). In certain embodiments, analysis module 140 is operable to propose any suitable transaction service based on transaction patterns, transaction timing, transaction amount, transaction accounts, transaction account balances, transaction account interest rates, available and/or qualifying financial products (e.g., lines of credit), transaction charges, or any other suitable transaction characteristic.

Modifications, additions, or omissions may be made to table 200. Table 200 may include more or less fields, and may include any information relevant to electronic transaction services, determining proposed electronic transaction services, determining advantages related to proposed electronic transaction services, proposed accounts for electronic transaction services, determining user 102 privileges for electronic transaction services, tracing electronic transaction services, or tracking user 102 adoption of electronic transaction services. Table 200 may include any suitable amount of information and may be stored in any suitable type or number of memories.

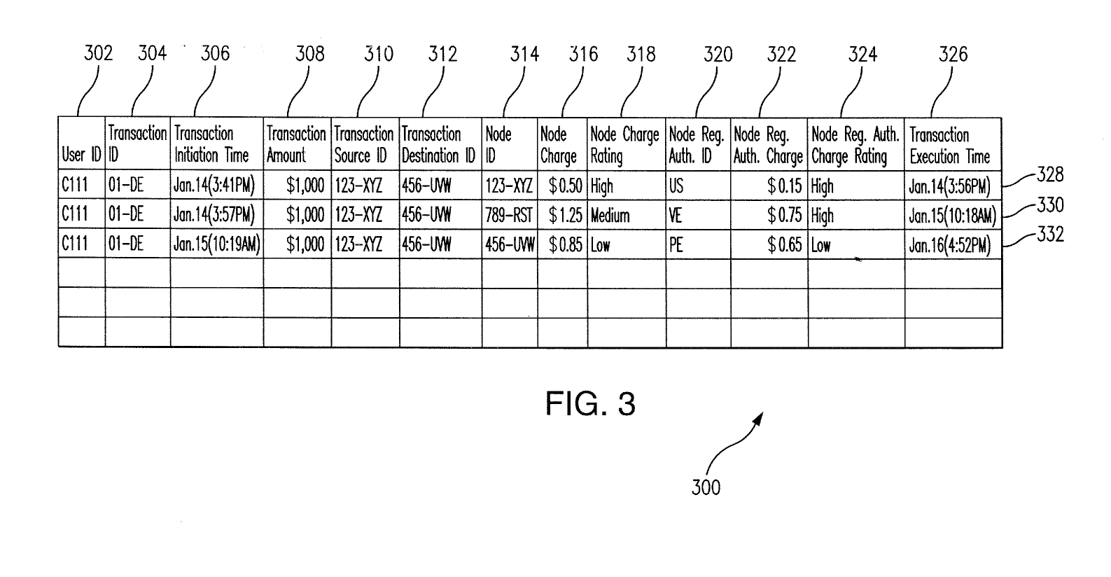

FIG. 3 illustrates a table of database fields that may be used in an example embodiment of executing electronic transaction services. In the illustrated embodiment, table 300 includes user ID field 302, transaction ID field 304, transaction initiation time field 306, transaction amount field 308, transaction source ID field 310, transaction destination ID field 312, node ID field 314, node charge field 316, node charge rating 318, node regulatory authority ID field 320, node regulatory authority charge field 322, node regulatory charge rating field 324, and transaction execution time field 326.

User ID field 302 represents a field that includes an identifier (e.g., ID code) for particular users 102 associated with particular electronic transaction services (e.g., fund transfers). Transaction ID field 304 represents a field that includes an identifier associated with particular electronic transaction services. Transaction initiation time field 306 represents a field that includes an initiation date and/or time associated with particular electronic transaction services. Transaction amount field 308 represents a field that includes an amount of money associated with a particular electronic transaction services. Transaction source ID field 310 represents a field that includes a source account (e.g., deposit account, investment account, CD account, payment account, or any other suitable financial account) associated with particular electronic transaction services. Transaction destination ID field 312 represents a field that includes a destination account (e.g., deposit account, investment account, CD account, payment account, or any other suitable financial account) associated with particular electronic transaction services.

Node ID field 314 represents a field that includes an identifier for particular nodes 104 associated with particular electronic transaction services. Node charge field 316 represents a field that includes a charge applied by nodes 104 for executing electronic transaction services. In certain embodiments, the value in node charge field 316 represents an estimated charge (e.g., based on researched charge data and/or previous fund transfer data). Node charge rating 318 represents a field that includes a quality rating (e.g., a confidence rating) for node 104 charge information. Node regulatory authority ID field 320 represents a field that includes an identifier for particular regulatory authorities 106 associated with nodes 104 associated with particular electronic transaction services. Node regulatory authority charge field 322 represents a field that includes a quality rating (e.g., a confidence rating) for regulatory authority 106 charge information. In certain embodiments, the value in regulatory authority charge field 316 represents an estimated charge (e.g., based on researched charge data and/or previous fund transfer data). Node regulatory charge rating field 324 represents a field that includes a charge applied by regulatory authorities 106 for particular electronic transaction services. Transaction execution time field 326 represents a field that includes an execution date and/or time associated with particular electronic transaction services.

Rows 328, 330, and 332 illustrate an example embodiment of database values for database fields that may be used to execute electronic transaction services. In the illustrated embodiment, rows 328, 330, and 332 represent a fund transfer of $1,000 from account ID 123-XYZ in the United States to account ID 456-UVW in Peru. Row 328 depicts a first portion of the transaction, where the user 102 initiating the transaction is depicted by user ID field 302 as C111, the identifier for the transaction is depicted by transaction ID field 304 as 01-DE, the initiation time of the transaction is depicted by transaction initiation time field 306 as January 14 at 3:41 PM, the transaction amount is depicted by transaction amount field 308 as $1,000, the source account of the transaction is depicted by transaction source ID field 310 as 123-XYZ, the destination account of the transaction is depicted by transaction destination ID field 312 as 456-UVW, the node 104 processing the first transfer portion is depicted by node ID field 314 as 123-XYZ (also the source account), the charge for processing the first transfer portion is depicted by node charge field 316 as $0.50, the confidence rating of the node charge is depicted by node charge rating field 318 as high, the regulatory authority 106 associated with node ID 123-XYZ is depicted by node regulatory authority ID field 320 as the United States, the charge from the regulatory authority 106 is depicted by node regulatory authority charge field 322 as $0.15, the confidence rating of the regulatory charge is depicted by node regulatory authority charge rating field 324 as high, and the execution time of the first portion of the transaction is depicted by transaction execution time field 326 as January 14 at 3:56 PM.

Row 330 depicts a second portion of the fund transfer, where the user 102 initiating the transaction is depicted by user ID field 302 as C111, the identifier for the transaction is depicted by transaction ID field 304 as 01-DE, the initiation time of the transaction is depicted by transaction initiation time field 306 as January 14 at 3:57 PM, the transaction amount is depicted by transaction amount field 308 as $1,000, the source account of the transaction is depicted by transaction source ID field 310 as 123-XYZ, the destination account of the transaction is depicted by transaction destination ID field 312 as 456-UVW, the node 104 processing the second transfer portion is depicted by node ID field 314 as 789-RST, the charge for processing the second transfer portion is depicted by node charge field 316 as $1.25, the confidence rating of the node charge is depicted by node charge rating field 318 as medium, the regulatory authority 106 associated with node ID 789-RST is depicted by node regulatory authority ID field 320 as Venezuela, the charge from the regulatory authority 106 is depicted by node regulatory authority charge field 322 as $0.75, the confidence rating of the regulatory charge is depicted by node regulatory authority charge rating field 324 as high, and the execution time of the first portion of the transaction is depicted by transaction execution time field 326 as January 15 at 10:18 AM.

Row 332 depicts a final portion of the fund transfer, where the user 102 initiating the transaction is depicted by user ID field 302 as C111, the identifier for the transaction is depicted by transaction ID field 304 as 01-DE, the initiation time of the transaction is depicted by transaction initiation time field 306 as January 15 at 10:19 AM, the transaction amount is depicted by transaction amount field 308 as $1,000, the source account of the transaction is depicted by transaction source ID field 310 as 123-XYZ, the destination account of the transaction is depicted by transaction destination ID field 312 as 456-UVW, the node 104 processing the final transfer portion is depicted by node ID field 314 as 456-UVW (same as the destination account), the charge for processing the final transfer portion is depicted by node charge field 316 as $0.85, the confidence rating of the node charge is depicted by node charge rating field 318 as low, the regulatory authority 106 associated with node ID 456-UVW is depicted by node regulatory authority ID field 320 as Peru, the charge from the regulatory authority 106 is depicted by node regulatory authority charge field 322 as $0.65, the confidence rating of the regulatory charge is depicted by node regulatory authority charge rating field 324 as low, and the execution time of the final portion of the transaction is depicted by transaction execution time field 326 as January 16 at 4:52 PM.

In certain embodiments, services module 120 is operable to provide estimated costs for electronic transaction services (e.g., fund transfers) to users 102 based on analysis of fund transfer data stored in storage module 130. Fund transfer data may be obtained from previous fund transfers involving nodes 104, regulatory authorities 106, third party enterprises 108, research organizations, or any other suitable source. In an embodiment, analysis module 140 assigns a rating to charge information associated with nodes 104 and/or regulatory authorities 106 based on the reliability of the charge information. Node 104 charge ratings and regulatory authority 106 charge ratings may be updated based on data from additional fund transfers, researched, or received charge data. In particular embodiments, nodes 104 and/or regulatory authorities with charge ratings lower than a certain threshold are not utilized in fund transfers. In certain embodiments, analysis module 140 is operable to identify patterns in fund transfers and identify proposed fund transfers with advantages to users 102 over existing fund transfers. Service module 120 may communicate proposed fund transfers (or other electronic transaction services) and advantages to users 102.

Analysis module 140 may be operable to identify patterns in timing, accounts, amounts, charges, transaction processing time, or any other suitable characteristic of fund transfers. In certain embodiments, analysis module 140 is operable to determine proposed fund transfers to replace or supplement existing fund transfers based on determined transaction patterns. For example, analysis module 140 may identify that user 102 A111 always makes a fund transfer from account 123-XYZ to an account in Peru on the fourteenth of every month. In an embodiment, analysis module 140 determines that the node 104 charge rating for the final transfer portion is low, and determines a proposed transaction through a different node 104 with a higher node 104 charge rating. Analysis module 140 may determine that node 104 456-UVW takes too long to process fund transfers based on the transaction initiation time and transaction execution time, and propose a different node 104 with faster processing times. In certain embodiments, analysis module 140 identifies that if user 102 initiates the fund transfer on an earlier date (e.g. the twelfth of the month instead of the fourteenth), that the total cost of the fund transfer is reduced.

Modifications, additions, or omissions may be made to table 300. Table 300 may include more or less fields, and may include any information relevant to electronic transaction services, determining proposed electronic transaction services, determining advantages related to proposed electronic transaction services, proposed accounts for electronic transaction services, determining user 102 privileges for electronic transaction services, tracing electronic transaction services, or tracking user 102 adoption of electronic transaction services. Table 300 may include any suitable amount of information and may be stored in any suitable type or number of memories.

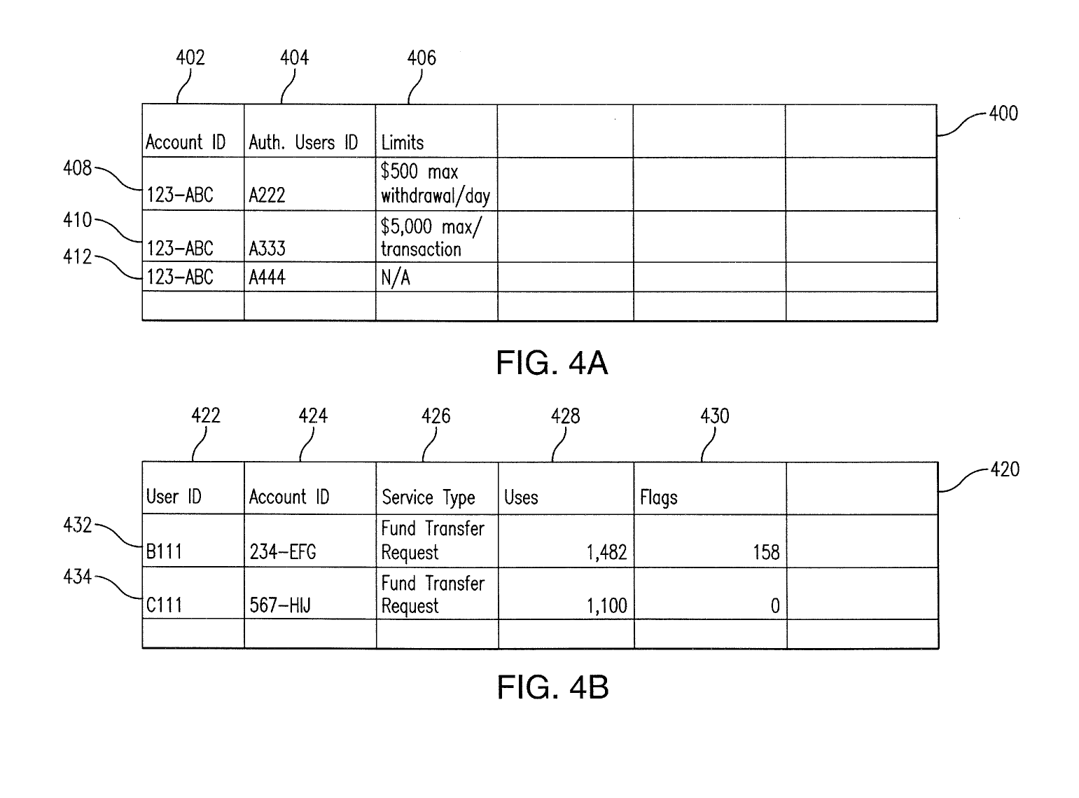

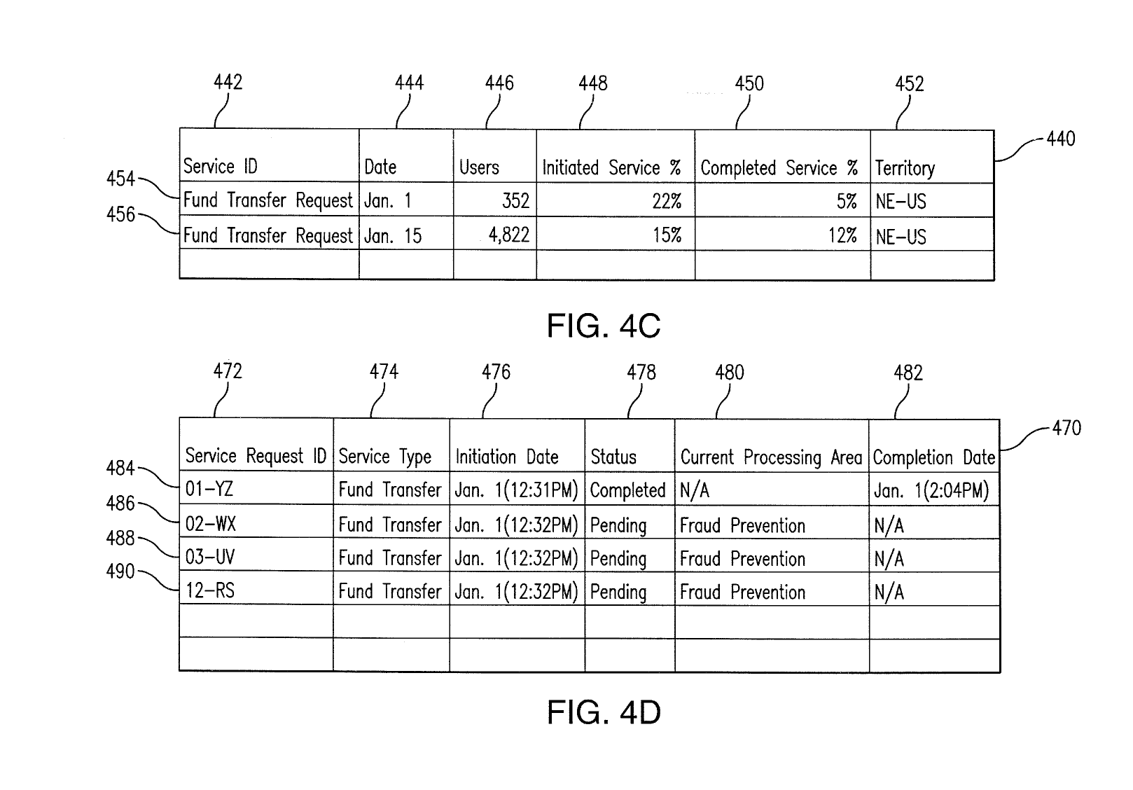

FIGS. 4A-D illustrate tables of database fields that may be used in example embodiments of executing electronic transaction services. FIG. 4A illustrates table 400, which includes account ID field 402, authorized users field 404, and limits field 406. Account ID field 402 represents a field that includes an identifier (e.g., ID code) of a particular financial account associated with particular electronic transaction services (e.g., fund transfers). Authorized users field 404 represents a field that includes identifiers for users 102 associated with particular financial accounts. Limits field 406 represents a field that includes limits to account privileges for particular users 102 associated with particular financial accounts.

Rows 408, 410, and 412 illustrate an example embodiment of database values for database fields that may be used to execute electronic transaction services. In the illustrated embodiment, rows 408, 410, and 412 represent limits to account privileges of authorized users 102 associated with an account. Authorized users ID field 404 includes A222 in row 408, A333 in row 410, and A444 in row 412. Account ID field 402 includes 123-ABC in rows 408, 410, and 412. Limits field 406 of row 408 includes a limit of a cap of $500 that can be withdrawn from account ID 402 123-ABC by authorized users ID 404 A222 per day. Limits field 406 of row 410 includes a limit of a cap of $5,000 that can be withdrawn from account ID 402 123-ABC by authorized users ID 404 A333 in any single transaction. Limits field 406 of row 412 includes no limit for authorized users ID 404 A444 for account ID 402 123-ABC.

In certain embodiments, administrative module 160 is operable to receive requests (e.g., from users 102 and/or service administrators 170) to change the account privileges of users 102. Administrative module 160 may query storage module 130 for account data associated with users 102, accounts, electronic transaction services, or any other suitable information related to account access privileges. In an embodiment, administrative module 160 is operable to change account access privileges for users 102 (e.g., in response to requests from users 102 and/or service administrators 170). Account access privileges may include viewing transactions on an account, executing particular transactions on an account (e.g., deposit but not withdrawal privileges), limits on particular transactions (e.g., limited transaction times or transaction based maximum dollar amounts), adding and/or removing users 102 from an account, or any other suitable access privilege for an account.

FIG. 4B illustrates table 420, which includes user ID field 422, account ID 424, service ID 426, uses 428, and flags 430. User ID field 422 represents a field that includes an identifier (e.g., ID code) for particular users 102 associated with particular electronic transaction services (e.g., fund transfers). Account ID 424 represents a field that includes an identifier of a particular financial account associated with particular electronic transaction services. Service type field 426 represents a field that includes an identifier of categories of electronic transaction services. Uses field 428 represents a field that includes a number of uses of an electronic transaction service (e.g., by one or more users 102). Flags field 430 represents a field that includes identified problems associated with one or more of users 102 and/or electronic transaction services (e.g., identified by users 102 and/or service administrators 170).

Rows 432 and 434 illustrate an example embodiment of database values for database fields that may be used to execute electronic transaction services. In the illustrated embodiment, rows 432 and 434 represent electronic transfer service use by users 102 and issue flags (e.g., abuse indicators and/or complaints) related to the service use. Row 432 shows that user ID field 422 includes B111, account ID field 424 includes 234-EFG, service type field 426 includes fund transfer request, uses field 428 includes 1,482, and flags field 430 includes 158. Row 434 shows that user ID field 422 includes C111, account ID field 424 includes 567-HU, service type field 426 includes fund transfer request, uses field 428 includes 1,100, and flags field 430 includes 0.

Administrative module 160 may receive issue flags associated with users 102 and/or electronic transaction services, for example, from users 102, service administrators 170, analysis module 140, or other source. In certain embodiments, administrative module 160 is operable to detect issue flags based on criteria received from service administrators 170. Issue flags may be related to abuse of an electronic transaction service by one or more users 102. In an embodiment, administrative module 160 may apply limits to users 102 electronic transactions service privileges as a result of issue flags. For example, limits may be added to users 102 at one or more threshold levels of issue flags. In certain embodiments, limits are applied to individual users 102, a plurality of users 102, or all users 102. Any suitable limit may be applied to electronic transaction services, for example, limits on the types of electronic transaction services, number of service uses, cost of service uses, amount of money in service uses (e.g., per unit time or per transaction), types of accounts, or any other suitable restriction.

For example, in the illustrated embodiment, both users 102 B111 and C111 have made a large number of fund transfer requests but only user 102 B111 has received issue flags related to the fund transfer requests. In an embodiment, administrative module 160 applies restrictions to users 102 for fund transfer requests after 1000 uses and prevents users 102 B111 and C111 from initiating any additional fund transfer requests. Administrative module 160 may apply restrictions to users 102 only if there are issue flags, and may ban user 102 B111 from additional fund transfer requests because that user 102 had 158 issue flags (e.g., complaints) and not restrict user 102 C111 because that user 102 has not had any issue flags.

FIG. 4C illustrates table 440, which includes service ID field 442, date field 444, users field 446, initiated service percentage field 448, completed service percentage field 450, and territory field 452. Service ID field 442 represents a field that includes an identifier of categories of electronic transaction services. Date field 444 represents a field that includes a date associated with particular electronic transaction services. Users field 446 represents a field that includes a number of users 102 associated with particular electronic transaction services (e.g., users 102 registered for a particular electronic transaction service). Initiated service percentage field 448 represents a field that includes a percentage of the number of users from users field 446 who have initiated a particular electronic transaction service. Completed service percentage field 450 represents a field that includes a percentage of the number of users from users field 446 who have completed a particular electronic transaction service. Territory field 452 represents a field that includes a geographical region associated with particular electronic transaction services.

Rows 454 and 456 illustrate an example embodiment of database values for database fields that may be used to execute electronic transaction services. In the illustrated embodiment, rows 454 and 456 represent numbers of users 102 that have initiated and that had completed a fund transfer request in two different territories at two different dates. Row 454 shows service ID field 454 includes fund transfer request, date field 444 includes January 1, users field 446 includes 352, initiated service percentage field 448 includes 22%, completed service percentage field 450 includes 5%, and territory field 452 includes (e.g., Northeastern United States). Row 456 shows service ID field 454 includes fund transfer request, date field 444 includes January 15, users field 446 includes 4,822, initiated service percentage field 448 includes 15%, completed service percentage field 450 includes 12%, and territory field 452 includes NE-US

Administrative module 160 may be operable to filter data (e.g., stored in storage module 130) related to registration (e.g., capability to execute an electronic transaction service), initiation, and completion of service requests associated with particular electronic transaction services (e.g., fund transfers) in particular territories. In certain embodiments, service administrators 170 communicate filter criteria to administrative module 160 and receive filtered data from administrative module 160. Service administrators 170 may identify electronic transaction services, date ranges, territories, and or other metrics affecting the registration, initiation, and completion of electronic service requests from the filtered data. In certain embodiments, service administrators 170 communicate electronic transaction service implementation changes to administrative module 160 to change the presentation (e.g., language, images, format, etc.) and/or functionality (e.g., service features) of electronic transaction services. Administrative module 160 may apply the implementation changes to one or more electronic transaction services, territories, types of users 102 (e.g., demographics), or any other subset of electronic transaction services. In particular embodiments, service administrators 170 check how the registration, initiation, and completion rates change in response to the implementation changes to determine whether the implementation changes were useful.

For example, in the illustrated embodiment, service administrators 170 may have determined that the number of registered users 102 in the NE-US territory was low, and executed an implementation change for the fund transfer service in the NE-US territory. After two weeks, service administrators 170 determined that registered users 446 increased from 352 to 4,822, that the initiation service percentage 448 dropped to 15% (but still represented a higher number of users 102 initiating service requests), and that the completion service percentage increased to 12%. From this information, service administrators 170 may determine that the implementation change was successful, and may determine to apply the implementation change to other territories 452.

FIG. 4D illustrates table 470, which includes service request ID field 472, service type field 474, initiation date field 476, status field 478, current processing area field 480, and completion date field 482. Service request ID field 472 represents a field that includes an identifier associated with particular requests for electronic transaction services. Service type field 474 represents a field that includes an identifier of categories of electronic transaction services. Initiation date field 476 represents a field that includes a date associated with initiation of an electronic transaction service. Status field 478 represents a field that includes an identifier of a status associated with particular electronic transaction services. Current processing area field 480 represents a field that includes an identifier of a system component currently responsible for processing an electronic transaction service request. Completion date field 482 represents a field that includes a date associated with completion of an electronic transaction service.

Rows 484, 486, 488, and 490 illustrate an example embodiment of database values for database fields that may be used to execute electronic transaction services. In the illustrated embodiment, rows 484, 486, 488, and 490 depict the components currently responsible for processing a number of fund transfer service requests on January 1. Row 484 shows that service request ID field 472 includes 01-YZ, service type field 474 includes fund transfer, initiation date field 476 includes January 1 at 12:31 PM, status field 478 includes completed, current processing area field 480 includes N/A, and completion date field 482 includes January 1 at 2:04 PM. Row 486 shows that service request ID field 472 includes 02-WX, service type field 474 includes fund transfer, initiation date field 476 includes January 1 at 12:32 PM, status field 478 includes pending, current processing area field 480 includes fraud prevention, and completion date field 482 includes N/A. Row 488 shows that service request ID field 472 includes 03-UV, service type field 474 includes fund transfer, initiation date field 476 includes January 1 at 12:32 PM, status field 478 includes pending, current processing area field 480 includes fraud prevention, and completion date field 482 includes N/A. Row 490 shows that service request ID field 472 includes 12-RS, service type field 474 includes fund transfer, initiation date field 476 includes January 1 at 12:32 PM, status field 478 includes pending, current processing area field 480 includes fraud prevention, and completion date field 482 includes N/A.

Administrative module 160 may be operable to track the status of electronic transaction service requests to identify service request processing issues (e.g., components failing to processes service requests within a threshold time). In an embodiment, administrative module 160 maintains a trace ID for each service request that includes a current status of each service request and/or a component currently processing the service request. Each component that processes a service request may update the corresponding trace ID to show the current status and progress of the service request. In certain embodiments, service administrators 170 access status information from administrative module 160 to determine the status and/or current processing component of one or more service requests. For example, in the illustrated embodiment, administrative module 160 may notify service administrators 170 that fund transfer transactions 02-WX, 03-UV, and 12-RS have been pending for longer than a threshold time period (e.g., one hour). In an embodiment, service administrators 170 are able to determine from rows 484, 486, 488, and 490 that transactions initiated after 12:31 PM have not completed and that the transactions are all in the fraud prevention processing area. From this information, service administrators 170 can quickly debug problems in system 100 and locate the source of processing problems.

Modifications, additions, or omissions may be made to tables 400, 420, 440, and/or 470. Tables 400, 420, 440, and/or 470 may include more or less fields, and may include any information relevant to electronic transaction services, determining proposed electronic transaction services, determining advantages related to proposed electronic transaction services, proposed accounts for electronic transaction services, determining user 102 privileges for electronic transaction services, tracing electronic transaction services, or tracking user 102 adoption of electronic transaction services. Tables 400, 420, 440, and/or 470 may include any suitable amount of information and may be stored in any suitable type or number of memories.

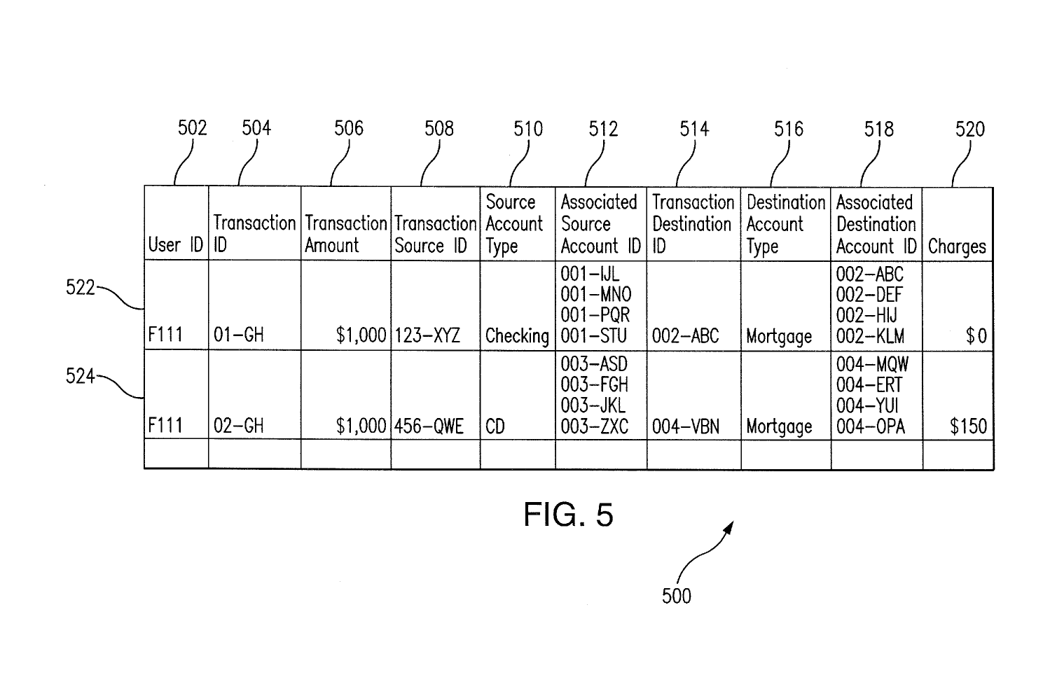

FIG. 5 illustrates a table of database fields that may be used in an example embodiment of executing electronic transaction services. Table 500 includes user ID field 502, transaction ID field 504, transaction amount field 506, transaction source ID field 508, source account type field 510, associated source account ID field 512, transaction destination ID field 514, destination account type field 516, associated destination account ID field 518, and charges field 520.

User ID field 502 represents a field that includes an identifier (e.g., ID code) for particular users 102 associated with particular electronic transaction services (e.g., fund transfers). Transaction ID field 504 represents a field that includes an identifier of a particular electronic transaction service. Transaction amount field 506 represents a field that includes an amount of money associated with a particular electronic transaction service (e.g., an amount of a fund transfer). Transaction source ID field 508 represents a field that includes an identifier of a source account (e.g., deposit account, investment account, CD account, payment account, or any other suitable financial account) associated with particular electronic transaction services. Source account type field 510 represents a field that includes an identifier of a category of a financial account associated with the source of an electronic transaction service. Associated source account ID field 512 represents a field that includes an identifier of one or more financial accounts (e.g., deposit account, investment account, CD account, payment account, or any other suitable financial account) associated with the source account of particular electronic transaction services. Transaction destination ID field 514 represents a field that includes an identifier of a destination account (e.g., deposit account, investment account, CD account, payment account, or any other suitable financial account) associated with particular electronic transaction services. Destination account type field 516 represents a field that includes an identifier of a category of a financial account associated with the destination of an electronic transaction service. Associated destination account ID field 518 represents a field that includes an identifier of one or more financial accounts (e.g., deposit account, investment account, CD account, payment account, or any other suitable financial account) associated with the destination account of particular electronic transaction services. Charges field 520 represents a field that includes particular charges associated with particular electronic transaction services.

Rows 522 and 524 illustrate an example embodiment of database values for database fields that may be used to execute electronic transaction services. In the illustrated embodiment, rows 522 and 524 represent electronic transaction services associated source and destination accounts, and charges. Row 522 shows that user ID field 502 includes F111, transaction ID field 504 includes 01-GH, transaction amount field 506 includes $1,000, transaction source ID field 508 includes 123-XYZ, source account type field 510 includes checking, associated source account ID field 512 includes 001-UL, 001-MNO, 001-PQR, and 001-STU, transaction destination ID field 514 includes 002-ABC, destination account type field 516 includes mortgage, associated destination account ID field 518 includes 002-ABC, 002-DEF, 002-HIJ, and 002-KLM, and charges field 520 includes $0. Row 524 shows that user ID field 502 includes F111, transaction ID field 504 includes 02-GH, transaction amount field 506 includes $1,000, transaction source ID field 508 includes 456-QWE, source account type field 510 includes certificate of deposit, associated source account ID field 512 includes 003-ASD, 003-FGH, 003-JKL, and 003-ZXC, transaction destination ID field 514 includes 004-VBN, destination account type field 516 includes mortgage, associated destination account ID field 518 includes 004-MQW, 004-ERT, 004-YUI, and 004-OPA, and charges field 520 includes $150.

Synchronization module 150 may determine one or more accounts associated with a source and/or destination of an account identified in an electronic transaction service (e.g., a fund transfer). These associated accounts may be presented to users 102 as options to include in electronic transaction services (e.g., as alternative source or destination accounts). In certain embodiments, synchronization module 150 is operable to apply transaction rules to electronic transaction services (e.g., limits on the types of accounts that can be used in certain transactions).

For example, in the illustrated embodiment, synchronization module 150 may determine associated source and destination account IDs 512 and 518 based on the transaction source and destination account IDs 508 and 514. In certain embodiments, the associated source and destination account IDs 508 and 514 may also be determined based on source account type 510 and destination account type 516. Synchronization module 150 may not allow retirement, credit, or certificate of deposit accounts in the associated source account ID field for row 522 because these accounts are not eligible to be source accounts for mortgage payments. Additionally, synchronization module 150 may recognize that row 524 is a mortgage payment with a certificate of deposit account type and propose the accounts in associated source accounts field 512 as replacement accounts because certificate of deposit accounts are not allowed to be source accounts for mortgage payments. In certain embodiments, synchronization module 150 may identify charges 520 associated with electronic transaction services. In the illustrated embodiment, the charge field 520 of row 524 is $150 because withdrawals from certificate of deposit accounts are subject to a penalty (e.g., $150).

Modifications, additions, or omissions may be made to table 500. Table 500 may include more or less fields, and may include any information relevant to electronic transaction services, determining proposed electronic transaction services, proposed accounts for electronic transaction services, determining advantages related to proposed electronic transaction services, determining user 102 privileges for electronic transaction services, tracing electronic transaction services, or tracking user 102 adoption of electronic transaction services. Table 500 may include any suitable amount of information and may be stored in any suitable type or number of memories

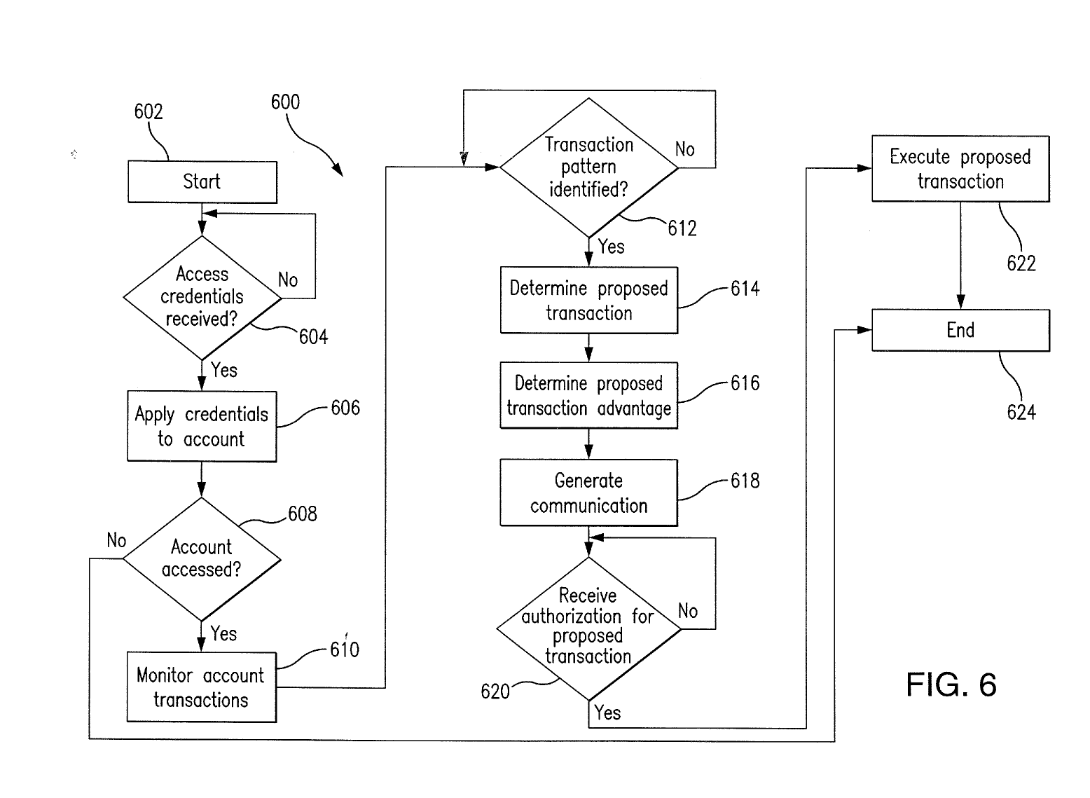

FIG. 6 illustrates an example embodiment of a method for executing electronic transaction services. Method 600 begins at step 602. At step 604, it is determined whether access credentials for one or more accounts have been received (e.g., by user 102). If no account access credentials have been received, the method returns to step 604 to continue to check for received access credentials. If account access credentials have been received, the method continues to step 606. At step 606, the access credentials are applied to the corresponding one or more accounts. At step 608, it is determined whether the applied access credentials successfully accessed the one or more accounts. If the applied access credentials do not successfully access an account, the method ends at step 622. If the applied access credentials successfully access an account, the method continues to step 610 and the transactions on the accounts are monitored.

At step 612, patterns in account transactions are identified (e.g., patterns in transaction amount, transaction source, transaction destination, transaction timing, transaction charges, interest on transaction accounts, or any other pattern in electronic transaction characteristics). If no patterns are identified, the method returns to step 612 to check account transactions for patterns. If a pattern is identified, a proposed transaction is determined at step 614 and an advantage to user 102 associated with the one or more accounts from the proposed transaction is determined at step 616. At step 618, a communication identifying the proposed transaction and the advantage is sent to user 102 associated with the one or more accounts. At step 620, it is determined whether authorization from user 102 to execute a proposed transaction associated with the one or more accounts has been received. If authorization has not been received, the method returns to step 620 to check for an authorization from user 102 of a proposed transaction. If authorization is received, the method continues to step 622 and the authorized proposed transaction is executed. The method ends at step 624.

Modifications, additions, or omissions may be made to method 600. The method may include more, fewer, or other steps. Additionally, steps may be performed in any suitable order, in parallel, and/or sequentially. Any suitable component of may perform one or more steps of method 600.

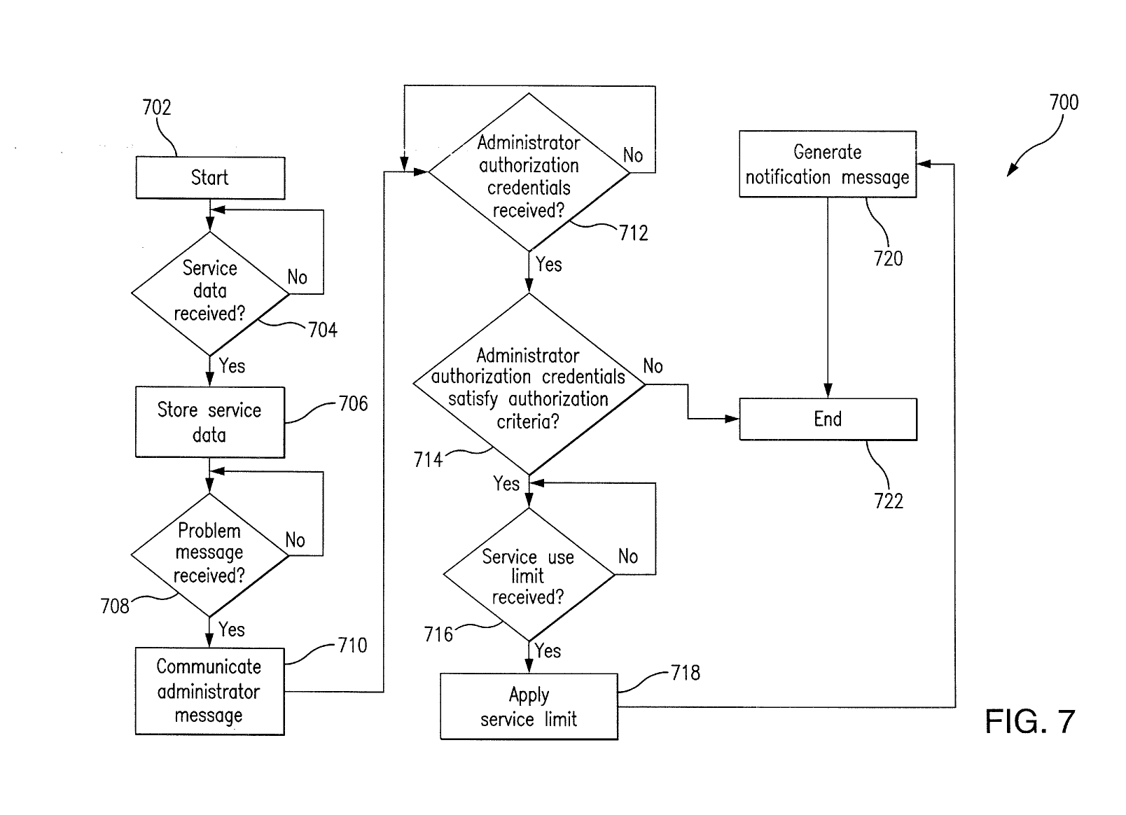

FIG. 7 illustrates an example embodiment of a method for executing electronic transaction services. Method 700 begins at step 702. At step 704, it is determined whether service data associated with electronic transaction services has been received. If service data has not been received, the method returns to step 704 to continue to check whether service data has been received. If service data has been received, the method continues to step 706 and the service data is stored. At step 708, it is determined whether a problem message identifying an electronic transaction service has been received. If a problem message has not been received, the method returns to step 708 to continue to check whether a problem message has been received. A problem message may include an identification of an electronic transaction service, user 102 associated with an electronic transaction service, and/or any other suitable information relevant to the problem with the electronic transaction service.

If a problem message has been received, the method continues to step 710 and an administrator message is communicated to one or more service administrators 170. An administrator message may include an identification of an electronic transaction service, user 102 associated with an electronic transaction service, and/or any other suitable information relevant to the problem with the electronic transaction service. At step 712, it is determined whether administrator authorization credentials have been received from one or more service administrators 170. Authorization credentials for service administrators 170 may be used to ensure that only authorized service administrators 170 can control electronic transaction service privileges and limits. If no authorization credentials have been received, the method returns to step 712 to continue to check for service administrator 170 authorization credentials. If authorization credentials have been received, the method continues to step 714 and it is determined whether the received service administrator 170 authorization credentials satisfy authorization criteria. If the received service administrator 170 authorization credentials do not satisfy the authorization criteria, the method ends at step 722. If the received service administrator 170 authorization credentials satisfy the authorization criteria, the method continues to step 716 and it is determined whether a limit to an electronic transaction service has been received from an authorized service administrator 170.

If a service limit has not been received from authorized service administrator 170, the method returns to step 716 to continue to check for a service limit from authorized service administrator 170. If a service limit has been received from authorized service administrator 170, the method continues to step 718 and the service limit is applied to one or more users 102. The limit may be applied to user 102 identified in a problem message and/or an administrator message. In certain embodiments, the limit applies to all users 102 or to a subset of users 102. The limit may grant electronic transaction service privileges to users 102 (e.g., adding users 102 to an account with particular access privileges and/or limits). At step 720, a notification message is generated for one or more users 102 affected by the applied service limit. At step 722, the method ends.

Modifications, additions, or omissions may be made to method 700. The method may include more, fewer, or other steps. Additionally, steps may be performed in any suitable order, in parallel, and/or sequentially. Any suitable component may perform one or more steps of method 700.

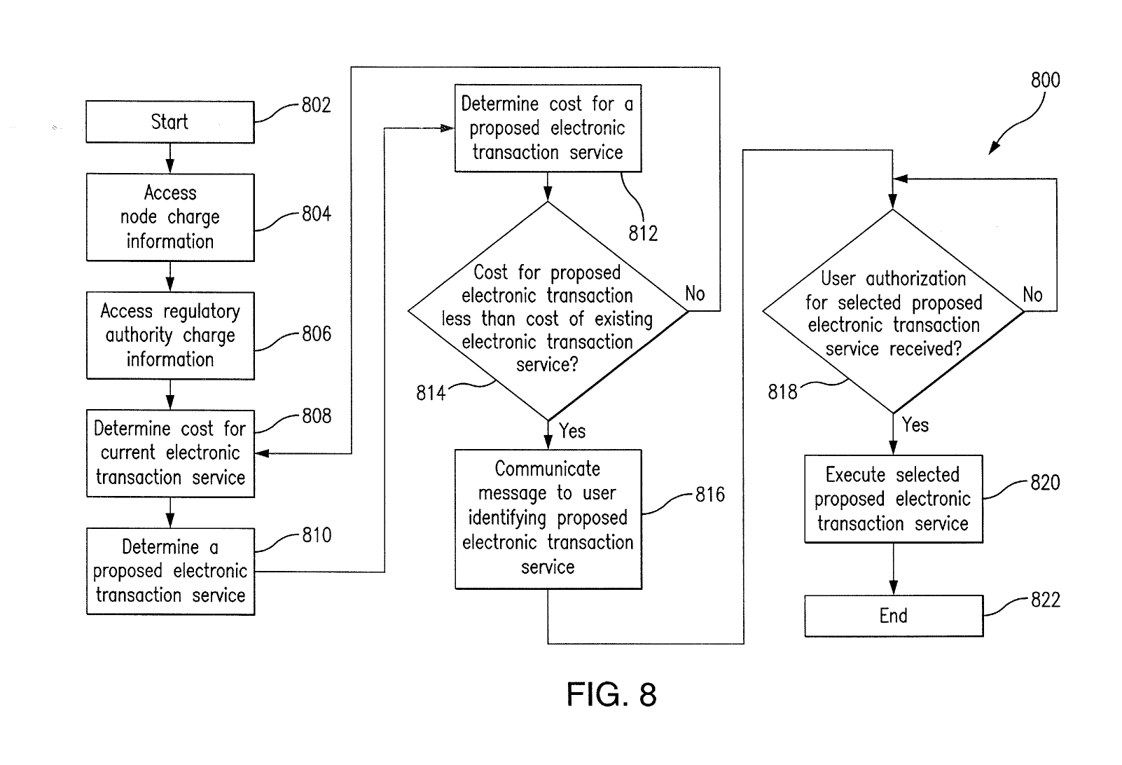

FIG. 8 illustrates an example embodiment of a method for executing electronic transaction services. Method 800 begins at step 802. At step 804, node 104 charge information is accessed (e.g., from storage module 130). At step 806, regulatory authority 106 charge information is accessed (e.g., from storage module 130). At step 808, a current cost for a current electronic transaction service involving one or more of the nodes 104 and regulatory authorities 106 is determined based on the accessed node 104 and regulatory authority 106 charge information (e.g., by analysis module 140). At step 810, a proposed electronic transaction service involving one or more of the nodes 104 and regulatory authorities 106 is determined that is associated with the current electronic transaction service (e.g., as a replacement for the current electronic transaction service or to supplement the current electronic transaction service). At step 812, a proposed cost for the proposed electronic transaction service is determined based on the accessed node 104 and regulatory authority 106 charge information (e.g., by analysis module 140).

At step 814, it is determined whether the proposed cost of the proposed electronic transaction service is lower than the current cost of the current electronic transaction service. If the proposed cost is not less than the current cost, the method returns to step 810 and a new proposed electronic transaction service is determined. If the proposed cost is less than the current cost, the method continues to step 816 and a proposed service message identifying the proposed electronic service is communicated to one or more users 102 associated with the current transaction service. In certain embodiments, the proposed service message includes an application (e.g., an embedded application or a hyperlink to an application) operable to allow the one or more users 102 to authorize the proposed electronic transaction service. At step 818, it is determined whether an authorization has been received from the one or more users 102 to execute the proposed electronic transaction service. If authorization has not been received, the method returns to step 818 to continue to check for authorization from the one or more users 102. If authorization has been received, the method continues to step 820 and the proposed electronic transaction service is executed. At step 822 the method ends.

Modifications, additions, or omissions may be made to method 800. The method may include more, fewer, or other steps. Additionally, steps may be performed in any suitable order, in parallel, and/or sequentially. Any suitable component of may perform one or more steps of method 800.

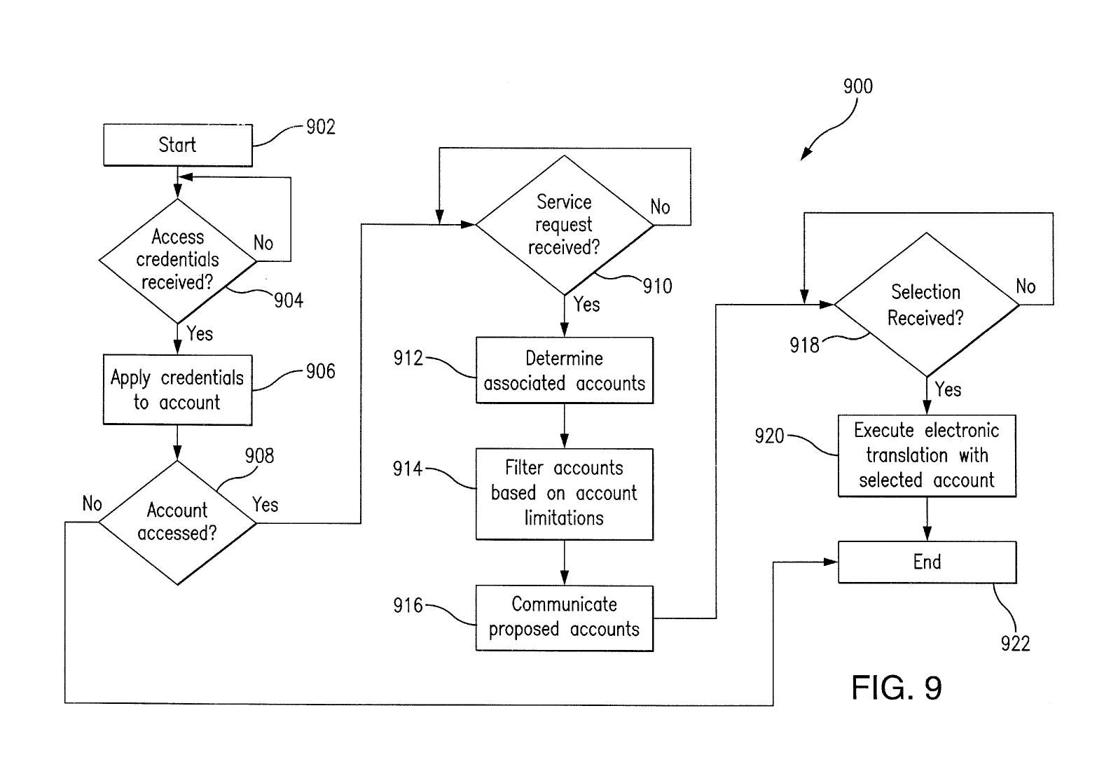

FIG. 9 illustrates an example embodiment of a method for executing electronic transaction services. Method 900 begins at step 902. At step 904, it is determined whether account access credentials have been received for a financial account. If account access credentials have not been received, the method returns to step 904 to continue to check for account access credentials. If account access credentials have been received, the method continues to step 906 and the account credentials are applied to the financial account. At step 908, it is determined whether the application of the account credentials to the financial account was successful and the account has been accessed. If the financial account has not been accessed, the method ends at step 922. If the financial account has been accessed, the method continues to step 910 and it is determined whether an electronic transaction service request (e.g., a fund transfer) involving the financial account has been received. If a service request has not been received, the method returns to step 910 to continue checking for a service request. If a service request has been received, the method continues to step 912 and additional financial accounts related to the financial account are identified.

At step 914, the additional accounts are filtered by transaction limitations based on the type of electronic transaction service requested in the service request. For example, transaction limitations may include fund transfers that are credit payments cannot be paid from credit accounts, fund transfers that are mortgage payments cannot be paid from credit accounts, retirement accounts or certificate of deposit accounts, or any other suitable electronic transaction service limitation. At step 916, the filtered additional accounts are communicated to user 102 associated with the service request as proposed accounts to use in the electronic transaction service request. At step 918, it is determined whether a proposed account selection has been received from user 102. If a selection has not been received, the method returns to step 918 to continue to check for a selection from user 102. If a selection has been received, the method continues to step 920 and the electronic transaction service is executed with the selected account. The method ends at step 922.

Modifications, additions, or omissions may be made to method 900. The method may include more, fewer, or other steps. Additionally, steps may be performed in any suitable order, in parallel, and/or sequentially. Any suitable component of may perform one or more steps of method 900.

Certain embodiments of the present disclosure may provide one or more technical advantages having specific technical effects. In certain embodiments, a system for executing electronic transaction services is operable to provide a user access to a plurality of accounts associated with the user through a single interface, thereby conserving the bandwidth, memory, and computational resources consumed by the user accessing the accounts through separate interfaces.

In an embodiment, a system for executing electronic transaction services is operable to propose electronic transaction services to users based on accessed electronic transaction service data from a plurality of accounts, thereby conserving the bandwidth, memory, and computational resources consumed by individual users each accessing the service data and determining the proposed transaction services.

In another embodiment, a system for executing electronic transaction services is operable to restrict use of electronic transaction services, thereby conserving the bandwidth, memory, and computational resources consumed by overuse of electronic transaction services.

In yet another embodiment, a system for executing electronic transaction services is operable to determine user registration, initiation, and/or completion of electronic transaction services, thereby conserving the bandwidth, memory, and computation resources consumed by obtaining user registration, initiation, and/or completion of electronic transaction services from users.

In still yet another embodiment, a system for executing electronic transaction services is operable to identify a system component currently responsible for an electronic transaction service, thereby conserving the bandwidth, memory, and computation resources consumed by searching all system components for the system component currently responsible for an electronic service transaction.

In a further embodiment, a system for executing electronic transaction services is operable to identify incorrect accounts involved in electronic transaction services before completing the electronic transaction service, thereby conserving the bandwidth, memory, and computation resources consumed by correcting erroneous electronic transaction services after completion.

In certain embodiments, a system for executing electronic transaction services is operable to determine costs associated with an electronic transaction before executing the transaction, thereby conserving the computational resources and bandwidth consumed by determining costs associated with transactions by executing and storing the results of numerous transactions.

In another embodiment, a system for executing electronic transaction services is operable to obtain charge information associated with electronic transaction services for a plurality of nodes and store the charge information in a centralized database before receiving a request to execute an electronic transaction, thereby reducing the computation resources and bandwidth consumed by attempting to obtain charge information from remote sources through a burst of requests after receiving a request to execute an electronic transaction.

In yet another embodiment, a system for executing electronic transaction services is operable to reduce transaction time associated with an electronic transaction by routing the transaction through nodes with the lowest transaction time, thereby reducing the computational resources and bandwidth consumed routing the transaction through nodes with longer transaction times.

In still yet another embodiment, a system for executing electronic transaction services is operable to increase the efficiency of the electronic transaction by routing the transaction on a route with the least number of nodes, thereby conserving the bandwidth and computational resources consumed by routes using more nodes.

In another embodiment, a system for executing electronic transaction services is operable to increase the efficiency of the electronic transaction by routing the transaction on a route with lowest transaction cost, thereby conserving the bandwidth and computational resources consumed by attempting transactions to determine their cost.

In yet another embodiment, a system for executing electronic transaction services is operable to increase the efficiency of electronic transaction services by maintaining updated charge information for nodes in order to avoid routing the transaction through nodes with inaccurate charge information, thereby conserving the computational resources and bandwidth consumed reconciling inaccuracies after a transaction has occurred (e.g., through customer service claims investigation).

Other technical advantages of the present disclosure will be readily apparent to one skilled in the art from the following figures, descriptions, and claims. Moreover, while specific advantages have been enumerated above, various embodiments may include all, some, or none of the enumerated advantages.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims.

What is claimed is:

1. A system for executing electronic transaction services, comprising:
one or more interfaces operable to receive access credentials for a plurality of accounts held with a plurality of enterprises, wherein the plurality of accounts are associated with an entity;
one or more processors communicatively coupled to at least one of the one or more interfaces, the one or more processors operable to:
access, based on the received access credentials, account data from the plurality of accounts;
monitor transactions in the plurality of accounts based on the accessed account data;
determine one or more transaction patterns based on the monitored transactions in the plurality of accounts;
determine a current charge associated with at least one of the one or more determined transaction patterns;
determine a current interest rate associated with at least one of the one or more determined transaction patterns;
determine a plurality of proposed transactions based on the one or more determined patterns, wherein the plurality of proposed transactions represent electronic transfers of funds involving one or more of the plurality of accounts, at least one of the plurality of proposed transactions is associated with a proposed charge that is less than the current charge, and at least one of the plurality of proposed transactions is a transfer of funds from an account associated with the current interest rate to an account associated with a proposed earned interest rate that is larger than the existing interest rate; and
determine one or more advantages to the entity associated with the plurality of proposed transactions; and
generate a notification message to a user associated with the entity describing the plurality of proposed transactions and the one or more advantages, wherein the notification message includes an application that allows the user to authorize one or more of the plurality of proposed transactions.

2. A system for executing electronic transaction services, comprising:
one or more interfaces operable to receive access credentials for a plurality of accounts held with a plurality of enterprises, wherein the plurality of accounts are associated with an entity;
one or more processors communicatively coupled to at least one of the one or more interfaces, the one or more processors operable to:
access, based on the received access credentials, account data from the plurality of accounts;
monitor transactions in the plurality of accounts based on the accessed account data;
determine one or more transaction patterns based on the monitored transactions in the plurality of accounts;
determine one or more proposed transactions based on the one or more determined patterns, wherein the one or more proposed transactions represent electronic transfers of funds involving one or more of the plurality of accounts; and
determine one or more advantages to the entity associated with the one or more proposed transactions; and
generate a notification message to a user associated with the entity describing the one or more proposed transactions and the one or more advantages.

3. The system of claim 2, the one or more processors further operable to determine a current charge associated with at least one of the one or more determined transaction patterns, wherein at least one of the one or more proposed transactions is associated with a proposed charge that is less than the existing charge.

4. The system of claim 2, the one or more processors further operable to determine a current interest rate associated with at least one of the one or more determined transaction patterns, wherein at least one of the one or more proposed transactions is a transfer of funds from an account associated with the current interest rate to an account associated with a proposed earned interest rate that is larger than the current interest rate.

5. The system of claim 2, wherein the transaction patterns are related to one or more from the set comprising: transaction timing, transaction amount, transaction source account, transaction destination account, transaction charges, interest rates associated with transaction accounts, and transaction account balances.

6. The system of claim 2, wherein the notification message includes an application that allows the user to authorize one or more of the proposed transactions.

7. The system of claim 2, wherein the plurality of accounts include one or more from the set comprising: checking accounts, savings accounts, retirement accounts, investment accounts, payment accounts, deposit accounts, and loan accounts

8. The system of claim 2, the one or more processors further operable to provide the accessed account data held by the plurality of enterprises to one or more users associated with the entity through an application.

9. A non-transitory computer readable storage medium comprising logic for executing electronic transaction services, the logic operable, when executed by a processor, to:
receive access credentials for a plurality of accounts held with a plurality of enterprises, wherein the plurality of accounts are associated with an entity;
access, based on the received access credentials, account data from the plurality of accounts;
monitor transactions in the plurality of accounts based on the accessed account data;
determine one or more transaction patterns based on the monitored transactions in the plurality of accounts;
determine one or more proposed transactions based on the one or more determined patterns, wherein the one or more proposed transactions represent electronic transfers of funds involving one or more of the plurality of accounts; and
determine one or more advantages to the entity associated with the one or more proposed transactions; and
generate a notification message to a user associated with the entity describing the one or more proposed transactions and the one or more advantages.

10. The non-transitory computer readable medium of claim 9, the logic further operable to determine a current charge associated with at least one of the one or more determined transaction patterns, wherein at least one of the one or more proposed transactions is associated with a proposed charge that is less than the existing charge.

11. The non-transitory computer readable medium of claim 9, the logic further operable to determine a current interest rate associated with at least one of the one or more determined transaction patterns, wherein at least one of the one or more proposed transactions is a transfer of funds from an account associated with the current interest rate to an account associated with a proposed earned interest rate that is larger than the current interest rate.

12. The non-transitory computer readable medium of claim 9, wherein the transaction patterns are related to one or more from the set comprising: transaction timing, transaction amount, transaction source account, transaction destination account, transaction charges, interest rates associated with transaction accounts, and transaction account balances.

13. The non-transitory computer readable medium of claim 9, wherein the notification message includes an application that allows the user to authorize one or more of the proposed transactions.

14. The non-transitory computer readable medium of claim 9, wherein the plurality of accounts include one or more from the set comprising: checking accounts, savings accounts, retirement accounts, investment accounts, payment accounts, deposit accounts, and loan accounts

15. The non-transitory computer readable medium of claim 9, the logic further operable to provide the accessed account data held by the plurality of enterprises to one or more users associated with the entity through an application.

16. A method for executing electronic transaction services, comprising:
receiving access credentials for a plurality of accounts held with a plurality of enterprises, wherein the plurality of accounts are associated with an entity;
accessing, by one or more processors, based on the received access credentials, account data from the plurality of accounts;
monitoring, by at least one of the one or more processors, transactions in the plurality of accounts based on the accessed account data;
determining, by at least one of the one or more processors, one or more transaction patterns based on the monitored transactions in the plurality of accounts;
determining, by at least one of the one or more processors, one or more proposed transactions based on the one or more determined patterns, wherein the one or more proposed transactions represent electronic transfers of funds involving one or more of the plurality of accounts; and
determining, by at least one of the one or more processors, one or more advantages to the entity associated with the one or more proposed transactions; and
generating a notification message to a user associated with the entity describing the one or more proposed transactions and the one or more advantages.

17. The method of claim 16, further comprising determining, by at least one of the one or more processors, a current charge associated with at least one of the one or more determined transaction patterns, wherein at least one of the one or more proposed transactions is associated with a proposed charge that is less than the existing charge.

18. The method of claim 16, further comprising determining, by at least one of the one or more processors, a current interest rate associated with at least one of the one or more determined transaction patterns, wherein at least one of the one or more proposed transactions is a transfer of funds from an account associated with the current interest rate to an account associated with a proposed earned interest rate that is larger than the current interest rate.

19. The method of claim 16, wherein the transaction patterns are related to one or more from the set comprising: transaction timing, transaction amount, transaction source account, transaction destination account, transaction charges, interest rates associated with transaction accounts, and transaction account balances.

20. The method of claim 16, wherein the notification message includes an application that allows the user to authorize one or more of the proposed transactions.
